(19) United States
(12) Patent Application Publication
(10) Pub. No.: US 2015/0183443 A1
(43) Pub. Date: Jul. 2, 2015

(54) FORCE GENERATION MECHANISM

(71) Applicant: HITACHI AUTOMOTIVE SYSTEMS, LTD., Ibaraki (JP)

(72) Inventors: Tsutomu Iwamura, Yokohama-shi (JP); Yusuke Akami, Yokohama-shi (JP); Noriyuki Utsumi, Setagaya-ku (JP); Tomoyuki Lee, Kawasaki-shi (JP); Yusei Kimura, Yokohama-shi (JP); Shunsuke Mori, Yokohama-shi (JP)

(21) Appl. No.: 14/410,789

(22) PCT Filed: Jun. 25, 2013
(86) PCT No.: PCT/JP2013/067332

§ 371 Date: Dec. 23, 2014

(30) Foreign Application Priority Data
Jun. 29, 2012 (JP) 2012-147359

(51) Int. Cl. B61F 5/24; F16F 15/03

(52) U.S. Cl. CPC B61F 5/24; F16F 15/03

(57) ABSTRACT

A damper apparatus (12) as the force generation mechanism mounted between a vehicle body (2) and a bogie (5) includes an attenuation damper (13), an electric damper (14), and a gear apparatus (15). The attenuation damper includes a rod protruding from a cylinder, and generates a damping force by converting motion energy of a forward or backward movement of the rod into heat energy. The electric damper includes a stator, and a movable element linearly movable relative to the stator. The gear apparatus is disposed between the attenuation damper and the electric damper, and can mechanically switch the attenuation damper and the electric damper between a series connection and a parallel connection. The gear apparatus switches a connection state between the attenuation damper and the electric damper according to the condition.

### TECHNICAL FIELD

The present invention relates to a force generation mechanism preferably used, as, for example, a damper apparatus for a vehicle such as a railway vehicle and an automobile.

### BACKGROUND ART

Generally, a damper apparatus such as a damping force adjustable shock absorber is mounted on a vehicle such as a railway vehicle and an automobile between a sprung side (a vehicle body side) and an unsprung side (a bogie side or an axle side). As one type of such a damper apparatus, there is known a damper apparatus configured to include a hydraulic damper and an electromagnetic damper arranged in parallel (for example, refer to Patent Document 1).

### CITATION LIST

### Patent Literature

Patent Document 1: Japanese Patent Application Public Disclosure No. 2003-252203 (Japanese Patent No. 4085368)

### SUMMARY OF INVENTION

According to the conventional technique discussed in Patent Document 1, the hydraulic damper and the electromagnetic damper are arranged in parallel. On the other hand, it is desirable to be able to use only any one of the hydraulic damper (an attenuation damper) and the electromagnetic damper (an electric damper), and use both of them (the attenuation damper and the electric damper) in parallel according to an operation condition or the like.

The present invention has been contrived in consideration of the drawback with the above-described conventional technique, and an object of the present invention is to provide a force generation mechanism capable of generating a desired force according to a condition.

To achieve the above-described object, the present invention is a force generation mechanism configured to be mounted between two members that are one member and the other member relatively movable to each other. The force generation mechanism includes a plurality of direct-drive force generation units, and a switching unit disposed between one and another of the force generation units and capable of mechanically switching the one and the another force generation units between a series connection and a parallel connection.

According to the present invention, it is possible to generate a desired force according to a condition.

### BRIEF DESCRIPTIONS OF DRAWINGS

FIG. 1 is a cross-sectional view illustrating a railway vehicle with a force generation mechanism according to a first embodiment of the present invention mounted thereon.

FIG. 2 is a cross-sectional view illustrating a bogie, the force generation mechanism, and the like taken along a direction indicated by arrows II-II illustrated in FIG. 1.

FIG. 3 is a perspective view schematically illustrating a switching unit and the like of the force generation mechanism.

FIG. 4 is a perspective view schematically illustrating the bogie, the force generation mechanism, and the like.

FIGS. 5(A) to (D) are plan views each schematically illustrating the force generation mechanism for each switched state (each operation mode) as viewed from the same direction as FIG. 2.

FIGS. 6(A) to (D) each schematically illustrate the force generation mechanism for each switched state for facilitating better understanding of an operation principle of the force generation mechanism.

FIG. 7 schematically illustrates the force generation mechanism together with variables indicating its state for facilitating better understanding of an operation of the force generation mechanism.

FIG. 8 is a block diagram illustrating a controller illustrated in FIG. 1.

FIG. 9 is a flowchart illustrating a content of control by the controller illustrated in FIG. 1.

FIG. 10 is a flowchart illustrating a content of processing in a normal operation mode illustrated in FIG. 9.

FIG. 11 is a flowchart illustrating a content of processing in a safe mode 1 illustrated in FIG. 9.

FIG. 12 is a flowchart illustrating a content of processing in a safe mode 2 illustrated in FIG. 9.

FIG. 13 is a flowchart illustrating a content of malfunction determination processing illustrated in FIG. 10.

FIG. 14 is a flowchart illustrating a content of processing for determining whether an electric damper is stuck that is illustrated in FIG. 11.

FIG. 15 is a transverse cross-sectional view illustrating a force generation mechanism according to a second embodiment of the present invention.

FIGS. 16(A) to (D) each schematically illustrate the force generation mechanism for each switched state for facilitating better understanding of an operation principle of the force generation mechanism.

FIG. 17 is a transverse cross-sectional view illustrating a force generation mechanism according to a third embodiment of the present invention.

FIG. 18 schematically illustrates a force generation mechanism according to a first modification of the present invention as viewed from the same direction as FIGS. 6(A) to 6(D).

FIG. 19 schematically illustrates a force generation mechanism according to a second modification of the present invention as viewed from the same direction as FIGS. 16(A) to (D).

FIG. 20 schematically illustrates a force generation mechanism according to a third modification of the present invention as viewed from the same direction as FIGS. 6(A) to (D).

FIG. 21 schematically illustrates a force generation mechanism according to a fourth modification of the present invention as viewed from the same direction as FIGS. 16(A) to (D).

FIG. 22 schematically illustrates a force generation mechanism according to a fifth modification of the present invention as viewed from the same direction as FIGS. 6(A) to (D).

FIG. 23 schematically illustrates a force generation mechanism according to a sixth modification of the present invention as viewed from the same direction as FIGS. 16(A) to (D).

FIG. 24 schematically illustrates a force generation mechanism according to a seventh modification of the present invention as viewed from the same direction as FIGS. 16(A) to (D).

FIG. 25 schematically illustrates a force generation mechanism according to an eighth modification of the present invention as viewed from the same direction as FIGS. 16(A) to (D).

### DESCRIPTION OF EMBODIMENTS

In the following description, force generation mechanisms according to embodiments of the present invention will be described in detail with reference to the accompanying drawings based on an example in which the force generation mechanism is applied to a damper apparatus mounted on, for example, a railway vehicle.

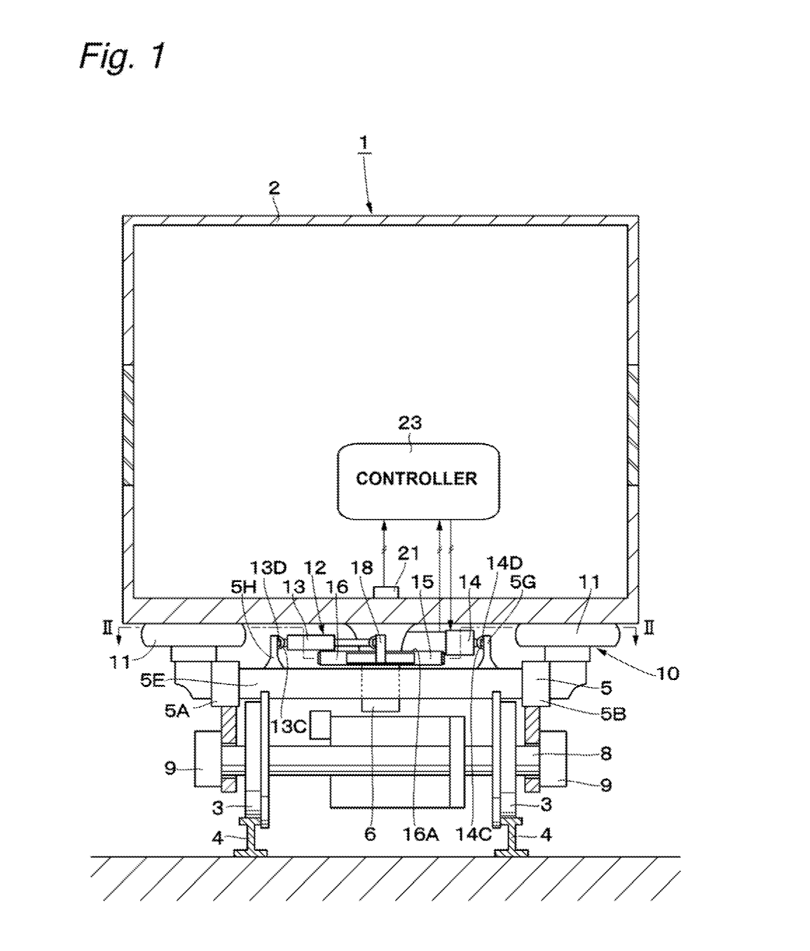

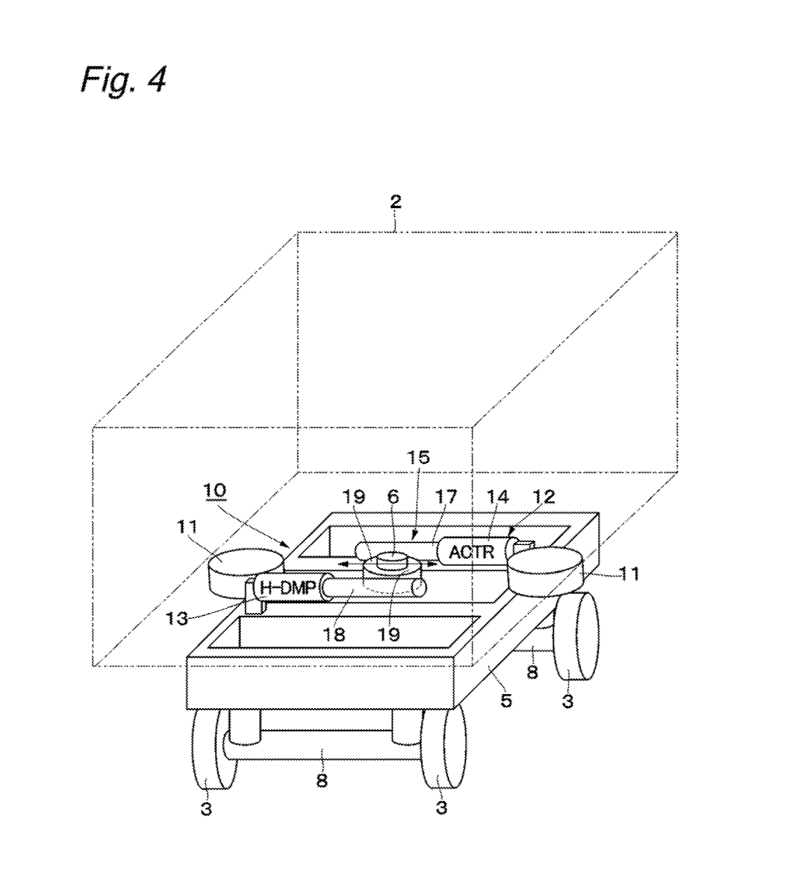

FIGS. 1 to 14 illustrate a first embodiment of the present invention. Referring to the drawings, a railway vehicle 1 generally includes a vehicle body 2 where, for example, passengers and crews axe aboard, and a bogie 5 disposed below the vehicle body 2 and guided by two rails 4 via vehicle wheels 3. FIGS. 1 and 4 illustrate only a single bogie 5 mounted on one side of the vehicle body 2 in a front-back direction, but actually, bogies 5 are mounted on both sides of the vehicle body 2 in the front-back direction, respectively.

A central pin 6 is fixedly provided on a bottom of the vehicle body 2, more specifically, at a portion on a bottom surface side of the vehicle body 2 that faces each of the bogies 5 in a vertical direction, so as to protrude downwardly from the bottom surface of the vehicle body 2. A pinion 19 of a gear apparatus 15 included in a damper apparatus 12 that will be described below is mounted on this central pin 6 via a bearing 7 such as a rolling bearing.

On the other hand, the bogie 5 generally includes a left side bolster 5A and a right side bolster 5B disposed so as to be spaced apart from each other in a left-right direction, and a front transverse bolster 5C, a central front transverse bolster 5D, a central back transverse bolster 5E, and a back transverse bolster 5F connecting these left and right side bolsters 5A and 5B. Then, the left and right side bolsters 5A and 5B rotatably support axles 8 with the vehicle wheels 3 mounted thereon via bearing apparatuses 9.

Further, a traction apparatus (not illustrated), which transmits a traction force and a control force applied in the front-back direction between the vehicle body 2 and the bogie 5, is disposed between the central pin 6 mounted on the vehicle body 2 and the central transverse bolsters 5D and 5E of the bogie 5. The traction apparatus includes a link mechanism having, for example, an I shape or a Z shape as viewed from above. Then, the traction apparatus connects the central pint 6 of the vehicle body 2 and the central transverse bolsters 5D and 5E of the bogie 5 so as to be able to transmit the traction force and the control force between the vehicle body 2 and the bogie 5 while allowing the vehicle body 2 to be displaced (moved) relative to the bogie 5 in the vertical direction, the left-right direction, a yaw (a bogie turning) direction, and a pitching direction.

Further, a mounting bracket 5G is disposed at the central front transverse bolster 5D of the bogie 5 at a position closer to one side in the left-right direction (the right side in the example illustrated in the drawings). An electric damper 14 (a stator 14A thereof) included in the damper apparatus 12 that will be described below is swingably mounted on this mounting bracket 5G via a pin-equipped rubber bush 14D. On the other hand, a mounting bracket 5H is disposed on the central back transverse bolster 5E at a position closer to the other side in the left-right direction (the left side in the example illustrated in the drawings). An attenuation damper 13 (a cylinder 13A thereof) included in the damper apparatus 12 that will be described below is swingably mounted on this mounting bracket 5H via a pin-equipped rubber bush 13D.

A suspension apparatus 10 is disposed between the vehicle body 2, which corresponds to a sprung side, and the bogie 5, which corresponds to an unsprung side. The suspension apparatus 10 generally includes pneumatic springs 11 supporting the vehicle body 2 swingably relative to the bogie 5 in the vertical direction and the left-right direction, and the damper apparatus 12 disposed between the vehicle body 2 (the central pin 6 mounted thereon) and the bogie 5 (the central transverse bolsters 5D and 5E thereof) and serving as a force generation mechanism. A pair of pneumatic springs 11 are disposed between the vehicle body 2 and the bogie 5 so as to be spaced apart from each other in the left-right direction. Since the bogies 5 are disposed on the both sides of the vehicle body 2 in the front-back direction, respectively, this railway vehicle 1 is configured to include two suspension apparatuses 10 in total, i.e., four pneumatic springs 11 and two damper apparatuses 12 in total for each vehicle (for each vehicle body).

Next, the damper apparatus 12, which damps a vibration between the vehicle body 2 and the bogie 5, will be described.

The damper apparatus 12 as the force generation mechanism is mounted between two members, the vehicle body 2 as one of relatively moving members, and the bogie 5 as the other of the relatively moving members. The damper apparatus 12 (actively and passively) generates a force (a thrust force and a damping force) between the vehicle body 2 and the bogie 5 to damp a vibration (a relative displacement) between the vehicle body 2 and the bogie 5. More specifically, the damper apparatus 12 is configured as a left-right movement damper apparatus to generate a force (a thrust force and a damping force) for reducing a vibration of the vehicle body 2 relative to the bogie 5 in the left-right direction to thereby damp the vibration of the vehicle body 2 in the left-right direction.

The damper apparatus 12 includes a plurality of direct-drive force generation units, more specifically, the attenuation damper 13 as one force generation unit and the electric damper 14 as another force generation unit, and a gear apparatus 15 as a switching unit is disposed between these attenuation damper 13 and electric damper 14. In other words, the damper apparatus 12 generally includes the attenuation damper 13 as the force generation unit, the electric damper 14 as the force generation unit, and the gear apparatus 15 as the switching unit.

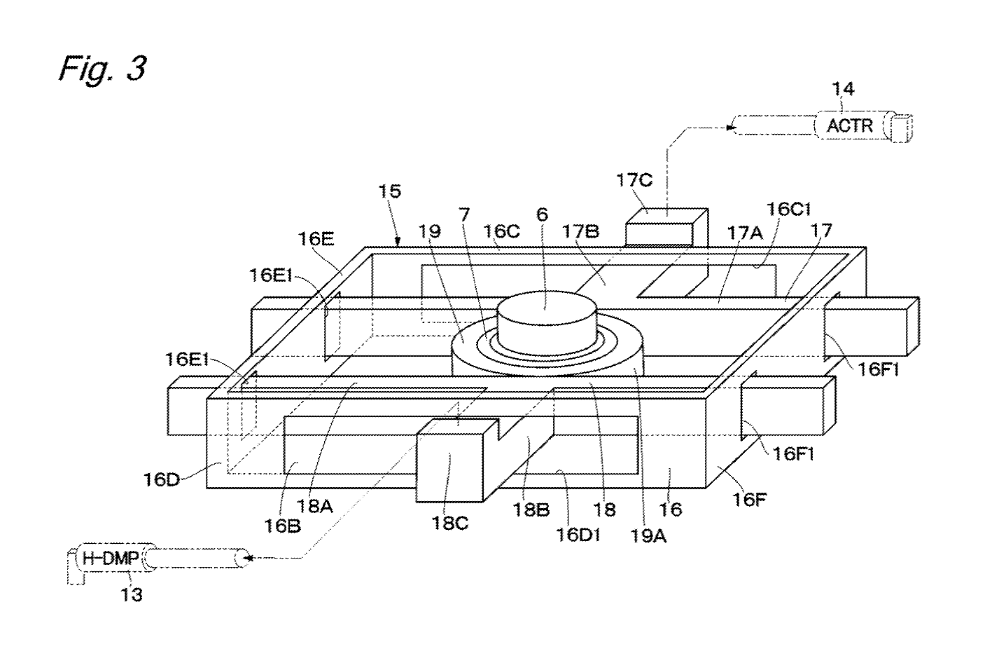

The attenuation damper 13 as the one force generation unit includes a rod 13B protruding from, the cylinder 13A, and generates a damping force by converting motion energy of a forward or backward movement of the rod 13B into heat energy. More specifically, the attenuation damper 13 is realized by, for example, a fluid pressure damper (a fluid pressure shock absorber) such as a hydraulic damper (a hydraulic shock absorber) that generates a damping force with use of hydraulic fluid (a viscous resistance thereof) such as hydraulic oil, or a fractional damper (a frictional shock absorber) that generates a damping force with use of a frictional resistance generated during a sliding movement between slidable surfaces. In FIGS. 3 to 6 (and FIGS. 16 and 18 to 25 that will be described below), a text “H-DMP”, which indicates the hydraulic damper as a representative example of the attenuation damper 13, is added to the attenuation damper 13 to allow the attenuation damper 13 to be easily distinguished from the electric damper 14 that will be described below.

The attenuation damper 13 generally includes the cylindrical cylinder 13A sealingly containing hydraulic fluid, a piston (not illustrated) displaceably contained in the cylinder 13A, the rod 13B having one-end side (a right-end side in FIGS. 1 to 5) protruding from one end of the cylinder 13A, and an opposite-end side (a left-end side in FIGS. 1 to 5) fixedly attached to the piston, and a damping force generation mechanism (not illustrated) disposed in the cylinder 13A including the piston and configured to damp a flow of the hydraulic fluid to thereby generate a damping force.

A mounting eye 13C for mounting a proximal end of the cylinder 13A onto the bogie 5 is provided at the proximal end (the left end in FIGS. 1 to 5) of the cylinder 13A, which corresponds to a bottom side of the attenuation damper 13. In this case, the pin-equipped rubber bush 13D is fixedly attached inside the mounting eye 13C, and a mounting pin of this pin-equipped rubber bush 13D is fixed to the mounting bracket 5H of the bogie 5 with use of a bolt or the like.

On the other hand, a mounting eye 13E for mounting a distal end of the rod 13B onto a rack 18 that will be described below is provided at the distal end (the right end in FIG. 1 to 5) of the rod 13B, which corresponds to a rod side of the attenuation damper 13. In this case, a pin-equipped rubber bush 13F is fixedly attached inside the mounting eye 13E, and a mounting pin of this pin-equipped rubber bush 13F is fixed to a damper mounting portion 18C of the rack 18 with use of a bolt or the like. The pin-equipped rubber bushes 13D and 13F absorb forces generated from rolling of the vehicle body 2 and yawing of the bogie 5 by elastic deformation of the rubber bushes.

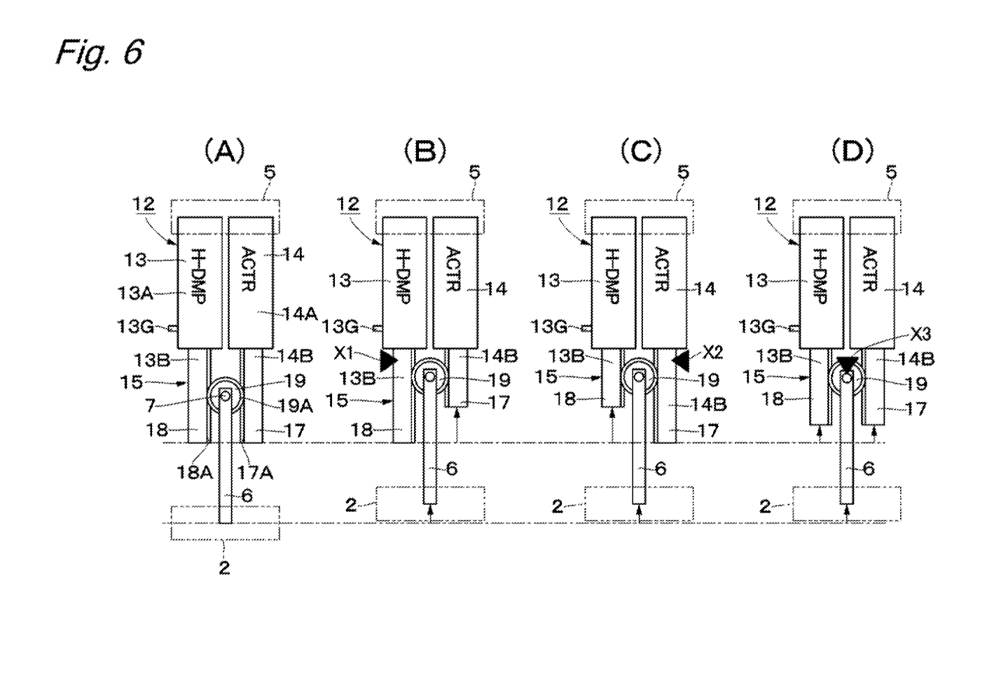

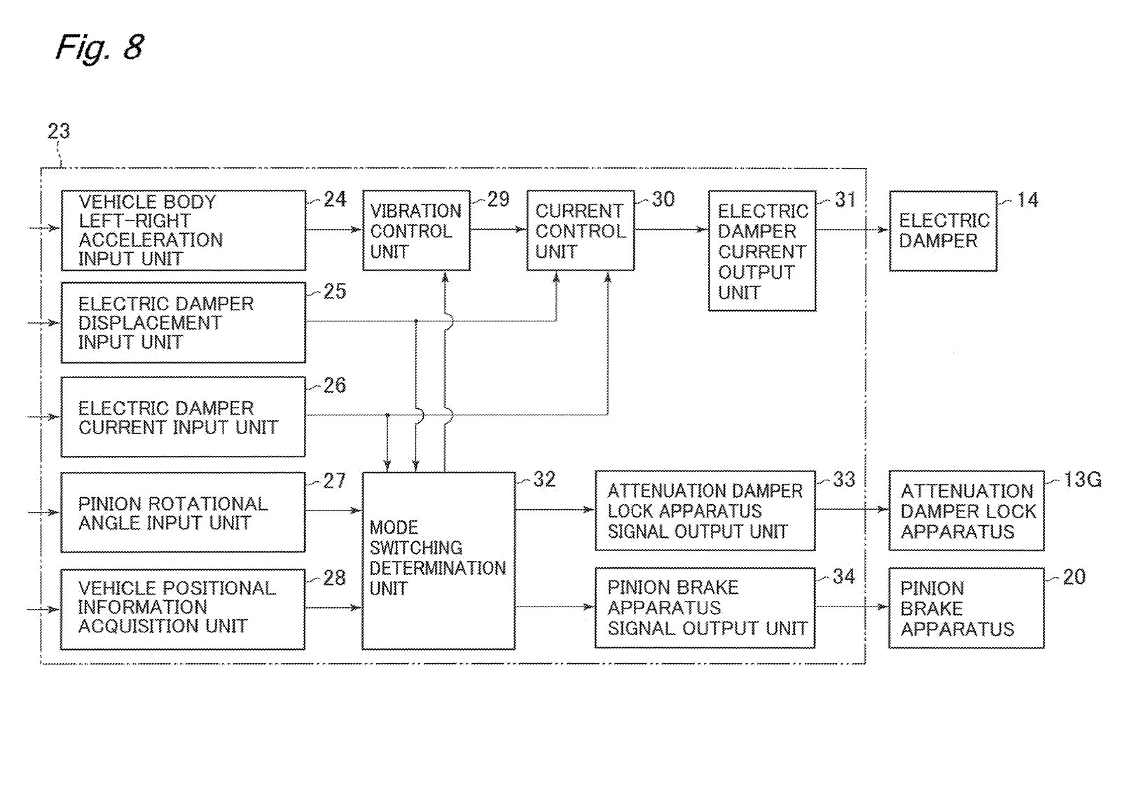

Further, an attenuation damper lock apparatus 13G (refer to FIGS. 6 and 8) is disposed at the attenuation damper 13 (or between the rod 13B of the attenuation damper 13 and the bogie 5) for prohibiting (blocking) a relative movement between the cylinder 13A and the rod 13B (a forward or backward movement of the rod 13B relative to the cylinder 13A). This attenuation damper lock apparatus 13G variably adjusts a resistance force against a relative displacement between the cylinder 13A and the rod 13B, and the relative movement between the cylinder 13A and the rod 13B is prohibited (locked) when the resistance force is maximized.

This attenuation damper lock apparatus 13G can employ, for example, a configuration that prohibits (forbids) a flow of the hydraulic fluid in the cylinder 13A, a configuration that mechanically fixes the rod 13B relative to the cylinder 13A, or a configuration that mechanically fixes the rod 13B relative to the bogie 5, as a configuration for maximizing the resistance force (locking the attenuation damper 13). In other words, the attenuation damper lock apparatus 13G can employ any of various kinds of configurations (a lock configuration and a brake configuration), such, as a configuration using friction, a configuration using a pin (engagement), and a configuration using a hydraulic pressure, as long as this configuration can acquire a required resistance force.

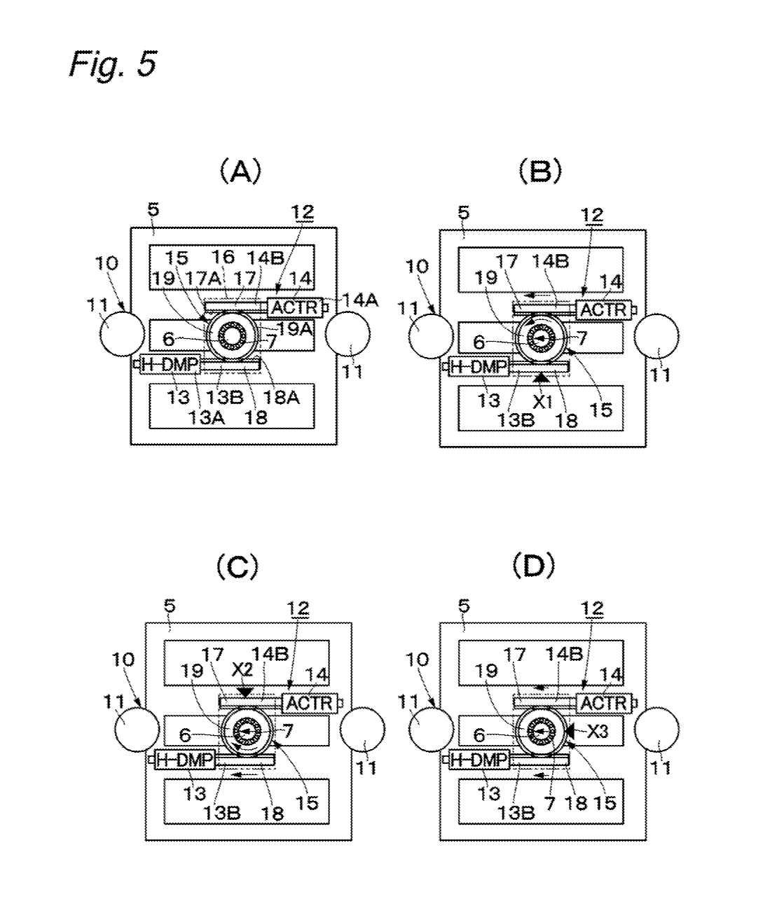

As illustrated in FIG. 8, the attenuation damper lock apparatus 13G is connected to a controller 23 that will be described below, and is switched between a locking state and an unlocking state (a releasing state) according to an instruction signal (a control signal) from this controller 23. For example, the attenuation damper lock apparatus 13G is switched to the locking state according to a signal from the controller 23 when the railway vehicle 1 is in a normal operation mode illustrated in FIGS. 5(B) and 6(B) that will be described below. In this case, it is possible to realize an operation state (an operation mode) using the electric damper 14 alone as will be described below.

The electric damper 14 as the another force generation unit includes the stator 14A, and a movable element 14B movable relative to this stator 14 in a linear direction. More specifically, the electric damper 14 is realized by an electric actuator that generates a force based on a supply of power (power energization), such as a linear motor (a linear actuator) such as a three-phase linear synchronous motor that generates a linear thrust force based on a force generated from attraction and repulsion between an armature (a coil thereof) and a permanent magnet. In FIGS. 3 to 6 (and FIGS. 16 and 18 to 25 that will be described below), a text “ACTR”, which indicates the electric actuator as a representative example of the electric damper 14, is added to the electric damper 14 to allow the electric damper 14 to be easily distinguished from the attenuation damper 13.

The electric damper 14 generally includes the cylindrical stator 14A including an armature with a plurality of coils provided thereon, and the movable element 14B including a plurality of cylindrical permanent magnets arranged side by side in an axial direction. Upon a supply of a current to the coils of the armature, an electromagnetic force is generated between the current flowing through the respective coils and the permanent magnets, and a thrust force (a damping force) is generated from this electromagnetic force. This thrust force is adjusted according to a thrust force instruction value (a control signal or an instruction current) output from the controller 23 (refer to FIG. 8) that will be described below.

A mounting eye 14C for mounting a proximal end of the stator 14A onto the mounting bracket 5G of the bogie 5 is provided at the proximal end (the right end in FIGS. 1 to 5) of the stator 14A. In this case, the pin-equipped rubber bush 14D is fixedly attached inside the mounting eye 14C, and a mounting pin of this pin-equipped rubber bush 14D is fixed to the mounting bracket 5G of the bogie 5 with use of a bolt or the like.

On the other hand, a mounting eye 14E for mounting a distal end of the movable element 14B onto a rack 17 that will be described below is provided at the distal end (the left end as shown in FIG. 1 to 5) of the movable element 14B of the electric damper 14. In this case, a pin-equipped rubber bush 14F is fixedly attached inside the mounting eye 14E, and a mounting pin of this pin-equipped rubber bush 14F is fixed to a damper mounting portion 17C of the rack 17 with use of a bolt or the like. The pin-equipped rubber bushes 14D and 14F absorb a force generated from rolling of the vehicle body 2 and yawing of the bogie 5 by elastic deformation of the rubber bushes.

An electric damper lock apparatus, which prohibits (forbids) a relative movement between the stator 14A and the movable element 14B (a forward or backward movement of the movable element 14B relative to the stator 14A), can be disposed at the electric damper 14 (or between the movable element 14B of the electric damper 14 and the bogie 5), if necessary. In this case, the electric damper lock apparatus can be configured to be able to realize a locking state according to an instruction (a signal) from the controller 23. Due to this configuration, the electric damper lock apparatus can create a state of a safe mode 2 illustrated in FIGS. 5(C) and 6(C) that will be described below, i.e., a state equivalent to such a state that the stator 14A and the movable element 14B of the electric damper 14 are fixed to each other (stuck to each other), according to the instruction from the controller 23. In other words, providing the electric damper lock apparatus allows the electric damper 14 to be locked (allows the movable element 14B to be fixed) according to the instruction from the controller 23, thereby creating an operation state (an operation mode) using the attenuation damper 13 alone.

The gear apparatus 15 as the switching unit is disposed between the attenuation damper 13 and the electric damper 14. The gear apparatus 15 allows the attenuation damper 13 and the electric damper 14 to be mechanically switched between a series connection and a parallel connection. Therefore, the gear apparatus 15 generally includes a gear case 16, the two racks 17 and 18, the pinion 19, and a pinion brake apparatus 20.

The gear case 16 is formed as a generally cuboid hollow box, and is mounted below the vehicle body 2 with the central pin 6 inserted (penetrating) at a center of the gear case 16. The gear case 16 includes a top plate portion 16A (refer to FIG. 1) facing the bottom surface of the vehicle body 2, a bottom plate portion 16B opposite of the racks 17 and 18 and the pinion 19 from the top plate portion 16A in the vertical direction, and a front plate portion 16C, a back plate portion 16D, a left plate portion 16E, and a right plate portion 16F surrounding the racks 17 and 18 and the pinion 19 on four sides between the top plate portion 16A and the bottom plate portion 16B.

Openings (not illustrated) are formed at central positions of the top plate portion 16A and the bottom plate portion 16B for insertion of the central pin 6, respectively. The top plate portion 16A and the bottom plate portion 16B are fixed to the central pin 16, which is the vehicle body side, with the central pin 16 inserted through their respective openings. An opening 16C1 is formed at the front plate portion 16C for insertion of an arm portion 17B of the rack 17, and an opening 16D1 is formed at the back plate portion 16D for insertion of an arm portion 18B of the rack 18. Relief holes 16E1 and 16F1 are formed at the left plate portion 16E and the right plate portion 16F for displaceable insertion of the racks 17 and 18, respectively.

The two racks (rack gears) 17 and 18 are disposed inside the gear case 16 so as to sandwich the pinion 19 in the front-back direction of the vehicle body 2. These two racks 17 and 18 are supported so as to be displaceable in the gear case 16 in the left-right direction via not-illustrated bearings, slidable members, and the like. The three members, the pair of racks 17 and 18 and the pinion 19 included in the gear apparatus 15, are mounted (attached) on the three elements, the electric damper 14, the attenuation damper 13, and the vehicle body 2, respectively, and the present embodiment is configured in such a manner that the racks 17 and 18 are mounted on the movable element 14B of the electric damper 14 and the rod 13B of the attenuation damper 13, respectively, and the pinion 19 is mounted on the vehicle body 2.

The rack 17 on the front side generally includes a tooth portion (a rack portion) 17A extending in the left-right direction and meshed with the pinion 19, and the arm portion 17B forwardly extending from a central position of the tooth portion 17A in the left-right direction. A distal-end side of the arm portion 17B protrudes from the opening 16C1 of the gear case 16, and the damper mounting portion 17C is provided at a distal end thereof. The mounting eye 14E of the movable element 14B of the electric damper 14 is mounted on this damper mounting portion 17C via the pin-equipped rubber bush 14F.

The rack 18 on the back side generally includes a tooth portion (a rack portion) 18A extending in the left-right direction and meshed with the pinion 19, and the arm portion 18B backwardly extending from a central position of the tooth portion 18A in the left-right direction. A distal-end side of the arm portion 18C protrudes from the opening 16D1 of the gear case 16, and the damper mounting portion 18C is provided at a distal end thereof. The mounting eye 13E of the rod 13B of the attenuation damper 13 is mounted on this damper mounting portion 18C via the pin-equipped rubber bush 13F.

The pinion (pinion gear) 19 is formed as an annular member including a tooth portion 19A meshed with the racks 17 and 18 on an outer circumferential side thereof, and is concentrically disposed with a rotational center (a center when turning) of the bogie 5. In this case, the pinion 19 is disposed so as to surround the central pin 6 downwardly extending from the vehicle body 2. More specifically, the pinion 19 is mounted on the central pin 6 so as to be rotatable relative to this central pin 6 via the rolling bearing 7. Then, the pinion 19 (the tooth portion 19A thereof) is meshed with the respective racks 17 and 18 (the tooth portions 17A and 18B) at two positions spaced apart from each other by 180 degrees in the front-back direction.

Therefore, when the pinion brake apparatus 20 that will be described below releases the pinion 19 (when the pinion 19 is freely rotatable), a displacement of the rack 17 or the rack 18 in the left-right direction causes the pinion 19 to rotate around the central pin 6 according to this displacement. In this case, for example, when the attenuation damper lock apparatus 13G is in the locking state, i.e., the rod 13B is fixed relative to the cylinder 13A, the rack 18 is fixed relative to the bogie 5. Therefore, when the rack 17 is displaced in the left-right direction based on a thrust force of the electric damper 14, the pinion 19 is displaced in the left-right direction while rotating around the central pin 6. Detailed operations of the attenuation damper 13, the electric damper 14, the racks 17 and 18, and the pinion 19 will be described below.

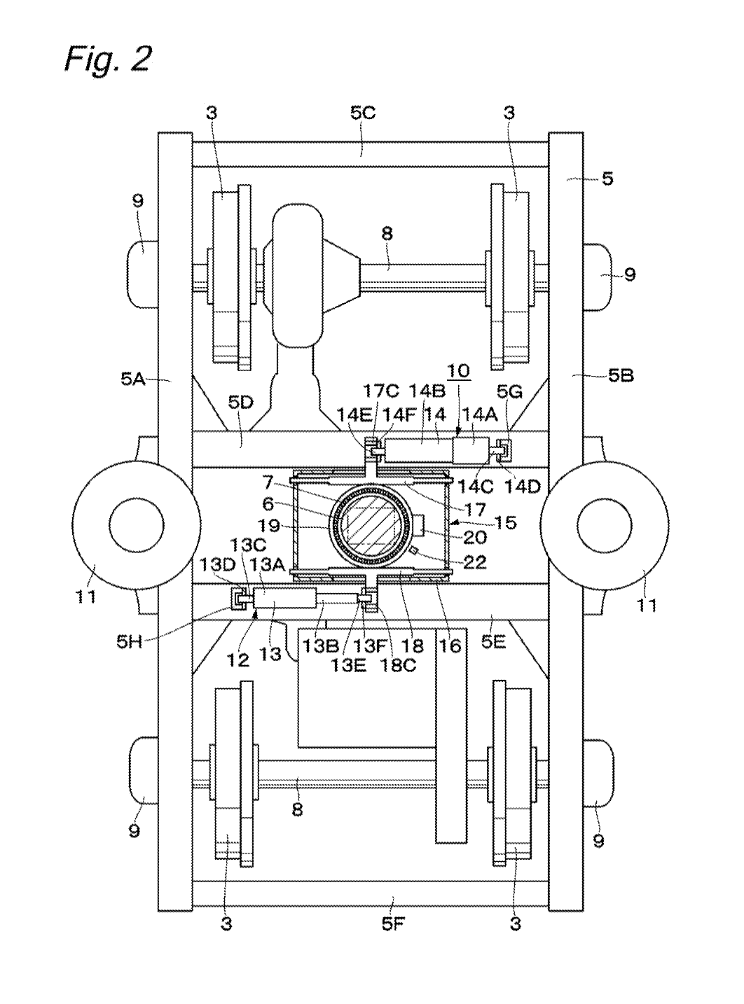

The pinion brake apparatus 20 (refer to FIGS. 2 and 8), which constitutes the gear apparatus 15 together with the racks 17 and 18 and the pinion 19, is disposed inside the gear case 16, for example, so as to face the pinion 19. The pinion brake apparatus 20 adjusts a frictional force of a gear of the pinion 19. More specifically, when the frictional force is maximized, the pinion brake apparatus 20 prohibits (forbids) the pinion 19 from rotating relative to the central pin 6 (the vehicle body 2). When the frictional force is minimized (when the frictional force is set to zero, or the pinion 19 is released), the pinion brake apparatus 20 allows (frees) the pinion 19 to rotate relative to the central pin 6 (the vehicle body 2).

The pinion brake apparatus 20 can be configured to, for example, include an engagement portion (not illustrated) that is frictionally engaged with the pinion 19. In other words, the pinion brake apparatus 20 can be configured to prohibit the pinion 19 from rotating by pressing the engagement portion against the pinion 19 (engaging the engagement portion with the pinion 19) when being in a braking state (a locking state) with the frictional force maximized, and allows the pinion 19 to rotate by retracting the engagement portion from the pinion 19 (disengaging the engagement portion from the pinion 19) when being in a not-braking state (a releasing state) with the frictional force minimized.

The pinion brake apparatus 20 does not necessarily have to be configured to use frictional engagement in this manner. In other words, the pinion brake apparatus 20 can employ any of various kinds of configurations (a brake configuration and a lock configuration), such as a configuration using friction, a configuration using a pin (engagement), and a configuration using a hydraulic pressure, as long as this configuration can acquire a required resistance force (a frictional force).

As illustrated in FIG. 8, the pinion brake apparatus 20 is connected to the controller 23 that will be described below, and is switched between the braking state (the locking state) and the not-braking state (the releasing state) according to an instruction signal (a control signal) from the controller 23. For example, the pinion brake apparatus 20 is switched to the braking state (the locking state) according to an instruction (a signal) from the controller 23 when the railway vehicle 1 is in the safe mode 1 illustrated in FIGS. 5(D) and 6(D) that will be described below. In this case, the attenuation damper 13 and the electric damper 14 are connected in parallel, and it is possible to realize the operation state (the operation mode) using both the attenuation damper 13 and the electric damper 14.

On the other hand, when the railway vehicle 1 is in the normal operation mode illustrated in FIGS. 5(B) and 6(B) or in the safe mode 2 illustrated in FIGS. 5(C) and 6(C), the pinion brake apparatus 20 is switched to the not-braking state (the releasing state) according to an instruction (a signal) from the controller 23, thereby allowing the pinion 19 to rotate around the central pin 6. In this case, the attenuation damper 13 and the electric damper 14 are mechanically connected in series. Then, when the attenuation damper 13 and the electric damper 14 are connected in series in this manner, fixing one of the attenuation damper 13 and the electric damper 14 (prohibiting the one from extending or compressing) can realize the operation state (the operation mode) using the other of the attenuation damper 13 and the electric damper 14 alone. For example, setting the attenuation damper lock apparatus 13G into the locking state can realize the operation mode using the electric damper 14 alone, i.e., the normal operation mode illustrated in FIGS. 5(B) and 6(B).

Next, an operation principle of the damper apparatus 12 will be described with reference to FIGS. 6(A) to (D). In FIGS. 6(A) to (D), the attenuation damper 13 and the electric damper 14 are illustrated as if they are arranged so as to have same extension and compression directions for facilitating better understanding of operations of the respective constituent members of the damper apparatus 12. Further, the rod 13B of the attenuation damper 13 and the movable element 14B of the electric damper 14 are schematically illustrated as if the racks 17 and 18 (the tooth portions 17A and 18B) are directly formed thereon in such a manner that the racks 17 and 18 face each other. Further, in FIGS. 6(A) to (D), a member corresponding to the central pin 6 illustrated in FIGS. 1 to 5, i.e., a member (a vehicle body coupling member) connecting (coupling) the vehicle body 2 and the pinion 9 to each other is illustrated as a rod-like member (a rod member).

A black triangle X1 illustrated in FIG. 6(B) indicates that the rod 13B is locked (fixed) by the attenuation damper lock apparatus 13G. A black triangle X2 illustrated in FIG. 6(C) indicates that the movable element 14B is locked (stuck or fixed) due to a malfunction of the electric damper 14 or by the electric damper lock apparatus provided as necessary. A black triangle X3 illustrated in FIG. 6(D) indicates that the pinion 19 is prohibited (locked) from rotating by the pinion brake apparatus 20.

FIG. 6(A) illustrates a neutral state (a neutral position and an initial position). This case corresponds to, for example, such a state that all of the attenuation damper lock apparatus 13G, the pinion brake apparatus 20, and the electric damper lock apparatus provided as necessary unlock (or lock) their respective targets.

FIG. 6(B) illustrates the normal operation mode, i.e., an active operation in which the attenuation damper lock apparatus 13G locks (fixes) the attenuation damper 13, and the pinion brake apparatus 20 (and the electric damper lock apparatus provided as necessary) unlocks the pinion 19 (and the electric damper 14). In this state, a relative displacement between the cylinder 13A and the rod 13B of the attenuation damper 13 is limited (prohibited) (the rod 13B is fixed relative to the bogie 5), while a relative displacement between the stator 14A and the movable element 14B of the electric damper 14, and a rotation of the pinion 19 are not limited (not prohibited).

In this case, when the central pin 6 (the pinion 19) is displaced (vibrates) together with the vehicle body 2 in the left-right direction (a vertical direction in FIGS. 6(A) to (D)) of the vehicle body 2 due to an input from the vehicle body side, the pinion 19 meshed with the rack 18 (the tooth portion 18A) of the rod 13B is displaced in the left-right direction of the vehicle body 2 (the vertical direction illustrated in FIGS. 6(A) to (D)) while rotating along the rack 18 (the tooth portion 18A) of the rod 13B based on this meshed engagement since a displacement of the rod 13B of the attenuation damper 13 is limited. At the same time, since the pinion 19 is also meshed with the rack 17 (the tooth portion 17A) of the stator 14A of the electric damper 14, the stator 14A is displaced by a displacement amount twice a displacement amount of the pinion 19 in the same direction as a displacement direction of the pinion 19 according to the displacement of the pinion 19 in the left-right direction (the vertical direction illustrated in FIGS. 6(A) to (D)).

At this time, the attenuation damper 13 is locked, whereby the attenuation damper 13 does not function to cancel out the movement of the electric damper 14 (does not interfere with the movement of the electric damper 14). Therefore, a force generated by the electric damper 14 is efficiently transmitted to the central pin 6 (the vehicle body 2). Further, a speed reduction mechanism (a reducer) is constructed between the pinion 39 and the racks 17 and 38, whereby a force twice the force generated by the electric damper 14 is transmitted to the central pin 6 (the vehicle body 2).

FIG. 6(C) illustrates the safe mode 2, i.e., a passive operation in which the attenuation damper lock apparatus 13G and the pinion brake apparatus 20 unlock the attenuation damper 13 and the pinion 19, respectively, and the electric damper 14 is locked (stuck or fixed) due to a malfunction of the electric damper 14 or by the electric damper lock apparatus provided as necessary. In this state, a relative displacement between the stator 14A and the movable element 14B of the electric damper 14 is limited (prohibited), while a relative displacement between the cylinder 13A and the rod 13B of the attenuation damper 13, and a rotation of the pinion 19 are not limited (not prohibited).

In this case, when the central pin 6 (the pinion 19) is displaced (vibrates) together with the vehicle body 2 in the left-right direction (the vertical direction in FIGS. 6(A) to (D)) of the vehicle body 2 due to an input from the vehicle body side, the pinion 19 meshed with the rack 17 (the tooth portion 17A) of the movable element 14B is displaced in the left-right direction of the vehicle body 2 (the vertical direction illustrated in FIGS. 6(A) to (D)) while rotating along the rack 17 (the tooth portion 17A) of the movable element 14B based on this meshed engagement since a displacement of the movable element 14B of the electric damper 14 is limited. At the same time, since the pinion 19 is also meshed with the rack 18 (the tooth portion 18A) of the rod 13B of the attenuation damper 13, the rod 13B is displaced by a displacement amount twice a displacement amount of the pinion 19 in the same direction as a displacement direction of the pinion 19 according to the displacement of the pinion 19 in the left-right direction (the vertical direction illustrated in FIGS. 6(A) to (D)).

At this time, since the electric damper 14 does not work, the movement of the central pin 6 (the vehicle body 2) (=the movement of the pinion 19) is absorbed by the attenuation damper 13. In this case, the speed reduction mechanism (the reducer) is constructed between the pinion 19 and the racks 17 and 18, whereby a force from the central pin 6 (the vehicle body 2) is transmitted to the attenuation damper 13 while being reduced to half.

FIG. 6(D) illustrates the safe mode 1, i.e., a parallel operation in which the attenuation damper lock apparatus 13G (and the electric damper lock apparatus provided when necessary) unlocks the attenuation damper 13 (and the electric damper 14), and the pinion brake apparatus 20 locks the pinion 19. In this state, a rotation of the pinion 19 is limited (prohibited), while a relative displacement between the stator 14A and the movable element 14B of the electric damper 14 and a relative displacement between the cylinder 13A and the rod 13B of the attenuation damper 13 are not limited.

In this case, when the central pin 6 (the pinion 19) is displaced (vibrates) together with the vehicle body 2 in the left-right direction (the vertical direction in FIGS. 6(A) to (D)) of the vehicle body 2 due to an input from the vehicle body side, the movable element 14B of the electric damper 14 and the rod 13B of the attenuation damper 13 are displaced by the same displacement amounts as a displacement amount of the pinion 19 in the same direction as a displacement direction of the pinion 19 according to the displacement of the pinion 19 in the left-right direction (the vertical direction illustrated in FIGS. 6(A) to (D)), since the rack 17 (the tooth portion 17A) of the movable element 14B of the electric damper and the rack 18 (the tooth portion 18B) of the rod 13B of the attenuation damper 13 are meshed with the pinion 19, and a rotation of the pinion 19 is limited (prohibited).

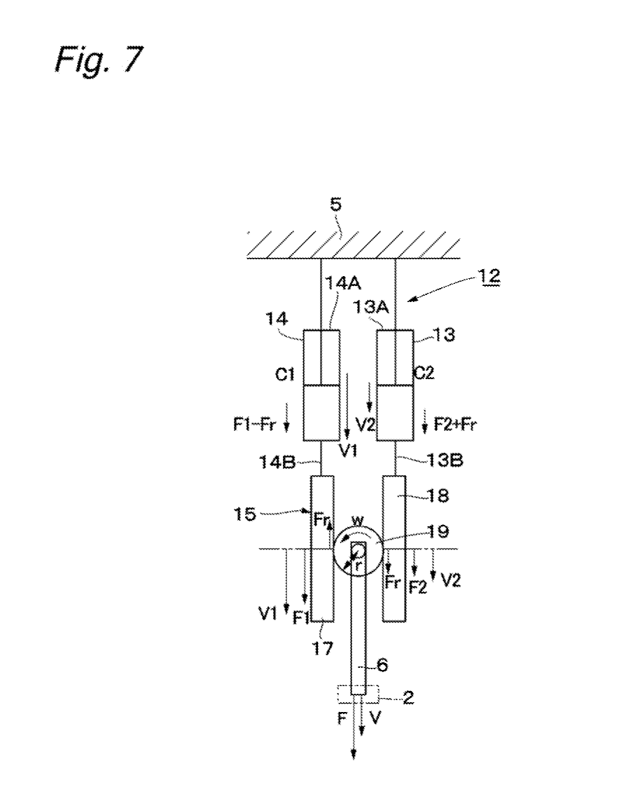

Next, the operation of the damper apparatus 12 will be described with use of variables defined in FIG. 7. In FIG. 7, the electric damper 14 is expressed as a fluid pressure shock absorber having a damping coefficient C1, and the attenuation damper 13 is expressed as a fluid pressure shock absorber having a damping coefficient C2 for simplification. Further, in FIG. 7, the member corresponding to the central pin 6 illustrated in FIGS. 1 to 5, i.e., the member (the vehicle body coupling member) connecting (coupling) the vehicle body 2 and the pinion 19 to each other is illustrated as a rod-like member (a rod member), in a similar manner to FIGS. 6(A) to (D).

The respective variables (parameters) illustrated in FIG. 7 are as follows. Directions indicated by arrows illustrated in FIG. 7 indicate directions of the respective variables.

v₁: a movement speed of the movable element 14B of the electric damper 14 [m/s]
F₁: the force generated by the movable element 14B of the electric damper 14 [N]
v₂: a movement speed of the rod 13B of the attenuation damper 13 [m/s]
F₂: the force generated by the rod 13B of the attenuation damper 13 [N]
ω: an angular speed of the pinion 19 [rad/s]
r: a radius of the pinion 19 [m]
Tᵣ: a braking torque of the pinion 19 [N·m]
Fᵣ: a braking force at a portion where the pinion 19 is meshed with each of the racks 17 and 18 (a contact point therebetween) [N]
Cᵣ: an equivalent rotational damping coefficient of the pinion 19 [N·m/rad/s]
v: a movement speed of the rod member (the central pin 6 and the vehicle body 2) ([m/s]
F: a force generated by the rod member (the central pin 6 and the vehicle body 2) [N]

In this case, relationships expressed by the following equations, equations 1 and 2, are established among the forces of the movable element 14B of the electric damper 14, the rod 13B of the attenuation damper 13, and the central pin 4 (the vehicle body 2), and the speeds of the movable element 14B of the electric damper 14, the rod 13B of the attenuation damper 13, and the central pin 4 (the vehicle body 2), respectively.

$$\begin{matrix}F = {F}_{1} + {F}_{2} & [ EQUATION 1 ] \\ v = \frac{1}{2} ( {v}_{1} + {v}_{2} ) & [ EQUATION 2 ]\end{matrix}$$

Regarding the rotational direction of the pinion 19, relationships expressed by the following equations, equations 3 and 4 are established.

$$\begin{matrix}ω = \frac{{v}_{1} - {v}_{2}}{r} & [ EQUATION 3 ] \\ {T}_{r} = 2 r {F}_{r} = {C}_{r} ω & [ EQUATION 4 ]\end{matrix}$$

From the equations 3 and 4, the braking force Fᵣ at the portion where the pinion 19 is meshed with each of the racks 17 and 18 (the contact point) can be expressed by the following equation, an equation 5, assuming that the pinion 19 corresponds to a rotational damper.

$${F}_{r} = {C}_{r} \frac{{v}_{1} - {v}_{2}}{2 {r}^{2}} \qquad [ EQUATION 5 ]$$

If C₀ [N/m/s] is defined to represent an equivalent damping coefficient of the pinion 19 in a linear direction while Cᵣ is defined to represent the equivalent damping coefficient of the pinion 19 in the rotational direction, a relationship expressed by the following equation, an equation 6 is established therebetween.

$${C}_{0} = \frac{{C}_{r}}{{r}^{2}} \qquad [ EQUATION 6 ]$$

In this case, the braking force Fᵣ at the portion where the pinion 19 is meshed with each of the racks 17 and 18 (the contact point) is expressed by the following equation, an equation 7 with use of only the variables for the linear direction.

$${F}_{r} = \frac{{C}_{0}}{2} ( {v}_{1} - {v}_{2} ) \qquad [ EQUATION 7 ]$$

Further, the force (the thrust force) generated by the electric damper 14 and the force (the damping force or the absorbing force) generated by the attenuation damper 13 are expressed by the following equations, equations 8 and 9 according to an equation for a balance between forces, respectively.

F₁−Fᵣ=C₁v₁ [EQUATION 8]

F₁−Fᵣ=C₂v₂ [EQUATION 9]

With use of these equations, a work of the electric damper 14, the attenuation damper 13, and the pinion 19 is expressed by the following equation, an equation 10 according to the law of the conservation of energy.

(F₁−Fᵣ)v₁+(F₂+Fᵣ)v₂+Tⱼω=Fv [EQUATION 10]

The left side of the equation 10 can be converted in the following manner.

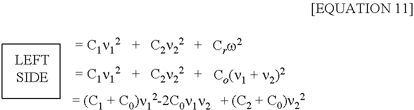

On the other hand, the right side of the equation 10 can be converted in the following manner.

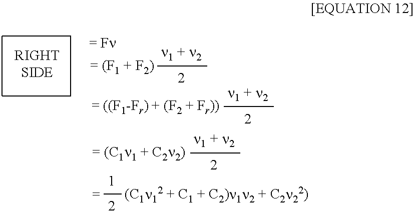

Since the left side=the right side, i.e., the equation 11=the equation 12, the equation 10 can be converted in the following manner.

$$( {C}_{1} + {C}_{0} ) {v}_{1}^{2} - 2 {C}_{0} {v}_{1} {v}_{2} + ( {C}_{2} + {C}_{0} ) {v}_{2}^{2} = \frac{1}{2} ( {C}_{1} {v}_{1}^{2} + ( {C}_{1} + {C}_{2} ) {v}_{1} {v}_{2} + {C}_{2} {v}_{2}^{2} ) \\ ( {C}_{1} + 2 {C}_{0} ) {v}_{1}^{2} - ( {C}_{1} + {C}_{2} + 4 {C}_{0} ) {v}_{1} {v}_{2} + ( {C}_{2} + 2 {C}_{0} ) {v}_{2}^{2} = 0 \qquad [ EQUATION 13 ]$$

$$( {v}_{1} - {v}_{2} ) ( ( {C}_{1} + 2 {C}_{0} ) {v}_{1} - ( {C}_{2} + 2 {C}_{0} ) {v}_{2 } ) = 0$$

Therefore, when the equation 13 is satisfied, a relationship expressed by the following equation, an equation 14 or 15 can be established between v₁ and v₂.

$$\begin{matrix}{v}_{1} = {v}_{2} & [ EQUATION 14 ] \\ {v}_{1} = \frac{{C}_{2} + 2 {C}_{0}}{{C}_{1} + 2 {C}_{0}} {v}_{2} & [ EQUATION 15 ]\end{matrix}$$

According to the equation 14, the pinion 19 is non-rotational, and the following equation, an equation 16 is established. This means that the electric damper 14 and the attenuation damper 13 are connected in parallel. In other words, the damper apparatus 12 can be considered as a parallel mechanism.

F=F₁+F₂,v=v₁=v₂ [EQUATION 16]

According to the equation 15, the pinion 19 is rotational, and the following equation, an equation 17 is established.

v₁+v₂=2v [EQUATION 17]

According to the equation 15, v₁ is expressed by an equation 18, and v₂ is expressed by an equation 19.

$$\begin{matrix}{v}_{1} = \frac{2 ( {C}_{2} + 2 {C}_{0} )}{{C}_{1} + {C}_{2} + 4 {C}_{0}} v & [ EQUATION 18 ] \\ {v}_{2} = \frac{2 ( {C}_{1} + 2 {C}_{0} )}{{C}_{1} + {C}_{2} + 4 {C}_{0}} v & [ EQUATION 19 ]\end{matrix}$$

Then, Fv can be expressed by an equation 20 according to the law of the conservation of energy, i.e., the equations 11 and 12

$$\begin{matrix}Fv = {C}_{1} {v}_{1}^{2} + {C}_{2} {v}_{2}^{2} + {C}_{0} {( {v}_{1} - {v}_{2} )}^{2} \\ = \frac{\begin{matrix}{{C}_{1} ( {C}_{2} + 2 {C}_{0} )}^{2} + \\ {{C}_{2} ( {C}_{1} + 2 {C}_{0} )}^{2} + {{C}_{0} ( {C}_{1} - {C}_{2} )}^{2}\end{matrix}}{{( {C}_{1} + {C}_{2} + 4 {C}_{0} )}^{2}} 4 {v}^{2} \\ = \frac{4 ( {C}_{1} + {C}_{2} + 4 {C}_{0} ) ( {C}_{1} {C}_{2} + {C}_{1} {C}_{0 } + {C}_{2} {C}_{0} )}{{( {C}_{1} + {C}_{2} + 4 {C}_{0} )}^{2}} {v}^{2} \\ = 4 \frac{{C}_{1} {C}_{2} + {C}_{1} {C}_{0} + {C}_{2} {C}_{0}}{{C}_{1} + {C}_{2} + 4 {C}_{0}} {v}^{2}\end{matrix} \qquad [ EQUATION 20 ]$$

Then, if a composite damping coefficient is expressed by the following equation, an equation 21 assuming that C represents the composite damping coefficient, Fv is expressed by an equation 22.

$$\begin{matrix}C = 4 \frac{{C}_{1} {C}_{2} + {C}_{1} {C}_{0} + {C}_{2} {C}_{0}}{{C}_{1} + {C}_{2} + 4 {C}_{0}} & [ EQUATION 21 ] \\ Fv = {Cv}^{2} & [ EQUATION 22 ]\end{matrix}$$

The composite damping coefficient C is an apparent damping coefficient of the damper apparatus 12 according to the present embodiment. According to the above-described equations, when C₀=0, the composite damping coefficient C of the equation 21 has a value expressed by the following equation, an equation 23

$$C = \frac{4 {C}_{1} {C}_{2}}{{C}_{1} + {C}_{2}} \qquad [ EQUATION 23 ]$$

In other words, when C₀=0, this state is equivalent to the electric damper 14 and the attenuation damper 13 being connected in series. On the other hand, when C₀=∞, the composite damping coefficient C of the equation 21 has a value expressed by the following equation, an equation 24.

$$\begin{matrix}C = 4 \frac{{C}_{1} {C}_{2} + {C}_{1} {C}_{0} + {C}_{2} {C}_{0}}{{C}_{1} + {C}_{2} + 4 {C}_{0}} \\ = \frac{\begin{matrix}{C}_{1}^{2} + {C}_{2}^{2} + 2 {C}_{1}^{2} {C}_{2} + \\ 4 {C}_{1} {C}_{0} + 4 {C}_{2} {C}_{0}\end{matrix}}{{C}_{1} + {C}_{2} + 4 {C}_{0}} - \frac{{C}_{1}^{2} - 2 {C}_{1} {C}_{2} + {C}_{2}^{2}}{{C}_{1} + {C}_{2} + 4 {C}_{0}} \\ = \frac{( {C}_{1} + {C}_{2} ) ( {C}_{1} + {C}_{2} + 4 {C}_{0} )}{{C}_{1} + {C}_{2} + 4 {C}_{0}} - \frac{{C}_{1}^{2} - 2 {C}_{1} {C}_{2} + {C}_{2}^{2}}{{C}_{1} + {C}_{2} + 4 {C}_{0}} \\ = {C}_{1} + {C}_{2} - \frac{{C}_{1}^{2} - 2 {C}_{1} {C}_{2} + {C}_{2}^{2}}{{C}_{1} + {C}_{2} + 4 {C}_{0}}\end{matrix} \qquad [ EQUATION 24 ]$$

Therefore, when C₀=∞, the composite damping coefficient C of the equation 21 has a value expressed by the following equation, an equation 25.

C=C₁+C₂ [EQUATION 25]

In other words, when C₀=∞, this state is equivalent to the electric damper 14 and the attenuation damper 13 being connected in parallel. Further, when 0<C₀<∞, the composite damping coefficient C has a value expressed by the equation 21, and this is an intermediate state between the parallel connection and the series connection. The above description reveals that the damper apparatus 12 according to the present embodiment is configured to be able to mechanically switch the two active and passive dampers (the force generation units) between the series connection and the parallel connection.

Then, when the railway vehicle 1 is in the normal operation mode illustrated in FIG. 6(B) (during the active operation), C₀=0 and C₂=∞, whereby the equation 23 is converted into the following equation, an equation 26.

$$\begin{matrix}C = 4 {C}_{1} ( \frac{{C}_{2}}{{C}_{1} + {C}_{2}} ) \\ = 4 {C}_{1} ( \frac{{C}_{1} + {C}_{2}}{{C}_{1} + {C}_{2}} - \frac{{C}_{1}}{{C}_{1} + {C}_{2}} ) \\ = 4 {C}_{1} - ( \frac{4 {C}_{1}^{2}}{{C}_{1} + {C}_{2}} )\end{matrix} \qquad [ EQUATION 26 ]$$

At this time, since C₂=∞, C is expressed by the following equation, an equation 27.

C=4C₁ [EQUATION 27]

Further, when the railway vehicle 1 is in the normal operation mode illustrated in FIG. 6(B) (during the active operation), v₂=0, whereby the equation 17 is converted into the following equation, an equation 28.

v₁=2v [EQUATION 28]

Therefore, F is expressed by the following equation, an equation 29.

$$\begin{matrix}F = Cv \\ = 4 {C}_{1} v \\ = 2 {C}_{1} {v}_{1} \\ = 2 {F}_{1}\end{matrix} \qquad [ EQUATION 29 ]$$

In other words, when the railway vehicle 1 is in the normal operation mode (during the active operation), the damper apparatus 12 as a whole exerts the thrust force F twice the thrust force F₁ of the electric damper 14.

Similarly, when the railway vehicle 1 is in the safe mode 2 illustrated in FIG. 6(C) (during the passive operation), the damper apparatus 12 as a whole also exerts the thrust force F twice the thrust force F₂ of the attenuation damper 13. In this case, the attenuation damper 13 according to the present embodiment should have a damping coefficient corresponding to one-fourth compared to a conventional attenuation damper used alone according to C=4C₂, to cause the damper apparatus 12 as a whole to exert a damping force similar to a configuration using the conventional attenuation damper alone. The parallel operation illustrated in FIG. 6(D) is as indicated by the equation 16.

Next, the switched states of the damper apparatus 12 will be described in correspondence with the operation states (the operation modes) of the railway vehicle 1 with reference to FIGS. 4 and 5. In FIGS. 4 and 5, the rod 13B of the attenuation damper 13 and the movable element 14B of the electric damper 14 are schematically illustrated as if the racks 17 and 18 (the tooth portions 17A and 18B) are directly formed thereon for facilitating better understanding of the operations of the respective portions of the vehicle body 2, the bogie 5, and the damper apparatus 12. Further, black triangles X1, X2, and X3 illustrated in FIGS. 5(A) to (D) indicate that a displacement of the rod 13B, a displacement of the movable element 14B, and a rotation of the pinion 19 are prohibited (forbidden) in a similar manner to FIGS. 6(A) to (D).

FIG. 5(A) corresponds to FIG. 6(A), and illustrates the neutral state (the initial position and the neutral position). This state corresponds to, for example, such a state that all of the rod 13B, the movable element 14B, and the pinion 19 are unlocked (or all of them are locked).

FIG. 5(B) corresponds to FIG. 6(B), and illustrates the normal operation mode (the active mode) in which a vibration between the vehicle body 2 and the bogie 5 is damped only by the electric damper 14 alone. In this mode, the attenuation damper lock apparatus 13G locks (fixes) the attenuation damper 13, and the pinion brake apparatus 20 unlocks the pinion 19.

In this case, when the vehicle body 2 and the bogie 5 are relatively displaced in the left-right direction due to an aerodynamic disturbance onto the vehicle body 2 while the railway vehicle 1 is running, a sway of the vehicle body 2 while the railway vehicle 1 is running on a curve, a sway of the bogie 5 due to a distortion of a track (the rail 4), or the like, the pinion 19 is displaced in the left-right direction of the vehicle body 2 while rotating along the locked rod 13B of the attenuation damper 13. At this time, the pinion 19 is also meshed with the rack 17 of the movable element 14B of the electric damper 14. Therefore, the movable element 14B controls (damps) a vibration between the vehicle body 2 and the bogie 5 while being displaced by a displacement amount twice a displacement amount of the vehicle body 2 (the pinion 19) in the same direction as a displacement direction of the vehicle body 2 (the pinion 19) according to the relative displacement between the vehicle body 2 and the bogie 5, i.e., the displacement of the pinion 19 relative to the bogie 5 in the left-right direction. In this case, a force twice the force generated by the electric damper 14 is applied to between the vehicle body 2 and the bogie 5 as a control force (a vibration damping force). Therefore, it is possible to use an electric damper generating a smaller force as the electric damper 14 compared to, for example, a configuration including an electric damper alone.

FIG. 5(C) corresponds to FIG. 6(C), and illustrates the safe mode 2 (the passive mode) into which the railway vehicle 1 is switched when the electric damper 14 becomes unable to perform a stroke (extension or compression) due to a malfunction of the electric damper 14, more specifically, a jam of the movable element 14B to the stator 14A (the movable element 14B is stuck to the stator 14A). In this mode, both the attenuation damper lock apparatus 13G and the pinion brake apparatus 20 unlock (release) the respective targets.

In this case, when the vehicle body 2 and the bogie 5 are relatively displaced in the left-right direction due to an aerodynamic disturbance onto the vehicle body 2 while the railway vehicle 1 is running, a sway of the vehicle body 2 while the railway vehicle 1 is running on a curve, a sway of the bogie 5 due to a distortion of a track (the rail 4), or the like, the pinion 19 is displaced in the left-right direction while rotating along the stuck movable element 14B of the electric damper 14. At this time, the pinion 19 is also meshed with the rack 18 of the rod 13B of the attenuation damper 13. Therefore, the rod 13B controls (absorbs) a vibration between the vehicle body 2 and the bogie 5 while being displaced by a displacement amount twice a displacement amount of the vehicle body 2 (the pinion 19) in the same direction as a displacement direction of the vehicle body 2 (the pinion 19) according to the relative displacement between the vehicle body 2 and the bogie 5, i.e., the displacement of the pinion 19 relative to the bogie 5 in the left-right direction. In this case, a force twice the force generated by the attenuation damper 13 is applied to between the vehicle body 2 and the bogie 5 as an absorption force (the vibration damping force).

FIG. 5(D) corresponds to FIG. 6(D), and illustrates the safe mode 1 (the parallel mode) into which the railway vehicle is switched when the thrust force of the electric damper 14 becomes insufficient due to a malfunction of the electric damper 14, more specifically, due to a stop of energization of the electric damper 14 (a power supply to the electric damper 14) or the like. In this mode, the pinion brake apparatus 20 is set into the braking (locking) state, while the attenuation damper lock apparatus 13G unlocks the attenuation damper 13.

In this case, when the vehicle body 2 and the bogie 5 are relatively displaced in the left-right direction due to an aerodynamic disturbance onto the vehicle body 2 while the railway vehicle 1 is running, a sway of the vehicle body 2 while the railway vehicle 1 is running on a curve, a sway of the bogie 5 due to a distortion of a track (the rail 4), or the like, the movable element 14B of the electric damper 14 and the rod 13B of the attenuation damper 13 are displaced by the same displacement amounts as a displacement amount of the pinion 19 in the same direction as a displacement direction of the pinion 19 according to the displacement of the pinion 19 in the left-right direction. At this time, it is possible to damp (absorb) a vibration between the vehicle body 2 and the bogie 5 by the attenuation damper 13 even with insufficiency of the thrust force of the electric damper 14.

In the normal operation mode (the active mode) illustrated in FIG. 5(B) and the safe mode (the passive mode) illustrated in FIG. 5(C), the movable element 14B of the electric damper 14 or the rod 13B of the attenuation damper 13 is displaced by the displacement amount twice the displacement amount between the bogie 5 and the vehicle body 2. For example, assuming that the railway vehicle 1 is running on a railroad line in operation with a relative displacement of approximately ±20 mm generated between the vehicle body 2 and the bogie 5, the movable element 14B of the electric damper 14 is displaced by approximately ±40 mm in the normal operation mode.

Then, a maximum displacement amount of the movable element 14B of the electric damper 14 is approximately ±100 to 140 mm, in consideration of a possibility of an input of a large relative displacement i.e., a large relative displacement of approximately ±50 to 70 mm between the vehicle body 2 and the bogie 5 when the railway vehicle 1 changes a line (passes through a point) in a rail yard or the pneumatic spring 11 is broken (goes flat). Therefore, setting a maximum stroke length (an allowable displacement amount) of the electric damper 14 according thereto may lead to an increase in the number of permanent magnets of the electric damper 14 that are arranged side by side in the axial direction, resulting in a cost increase.

Therefore, a possible solution therefor is to configure the railway vehicle 1 so as to be switched from the normal operation mode to the safe mode 1 (the parallel mode) even without a malfunction of the electric damper 14 (insufficiency of the thrust force), when a large relative displacement is generated between the vehicle body 2 and the bogie 5, such as the line change in the rail yard or the breakage of the pneumatic spring 11. In this case, i.e., in the safe mode 1 (the parallel mode), the displacement amount of the movable element 14B of the electric damper 14 or the displacement amount of the rod 13B of the attenuation damper 13 matches the displacement amount between the vehicle body 2 and the bogie 5, whereby it is possible to reduce the maximum stroke length of the electric damper 14. For example, the maximum stroke length of the electric damper 14 can be set to the same length (approximately ±50 to 70 mm) as the conventional configuration (the configuration including the electric damper alone).

When the railway vehicle 1 is in the safe mode 2 (the passive mode) illustrated in FIG. 5(C), i.e., when the electric damper 14 becomes unable to perform a stroke due to a jam of the movable element 14B to the stator 14A (the movable element 14B is stuck to the stator 14A), the railway vehicle 1 may arrive at the rail yard in this state. In consideration of this possibility, it is preferable to secure a length (approximately ±100 to 140 mm) twice the conventional configuration (the configuration including the attenuation damper alone) as a maximum stroke length (an allowable displacement amount) of the attenuation damper 13.

Next, an acceleration sensor 21 mounted on the vehicle body 2 and a pinion rotational sensor 22 mounted on the gear apparatus 15 will be described.

As illustrated in FIG. 1, the acceleration sensor 21 is mounted on the vehicle body 2 at a position close to the damper apparatus 12. This acceleration sensor 21 detects an acceleration (a vehicle body left-right acceleration) of a vibration of the vehicle body 2 in the left-right direction on the vehicle body side, which corresponds to the sprung side of the railway vehicle 1, and outputs a signal from this detection to the controller 23 that will be described below. For example, the acceleration sensor 21 is mounted for each of the bogies 5 in correspondence of each of the bogies 5 disposed on the both sides of the vehicle body 2 in the front-back direction, whereby the railway vehicle 1 is configured to include two acceleration sensors 21 in total for each vehicle (for each vehicle body).

As illustrated in FIG. 2, the pinion rotational sensor 22 is mounted on the gear case 16 of the gear apparatus 15 at, for example, a position facing the pinion 19. This pinion rotational sensor 22 detects a rotation of the pinion 19, and outputs a signal from this detection to the controller 23 that will be described below.

Next, the controller 23, which controls the damper apparatus 12, i.e., controls damping of a vibration between the vehicle body 2 and the bogie 5 (controls an output of the electric damper 14) and controls switching of the gear apparatus 15, will be described.

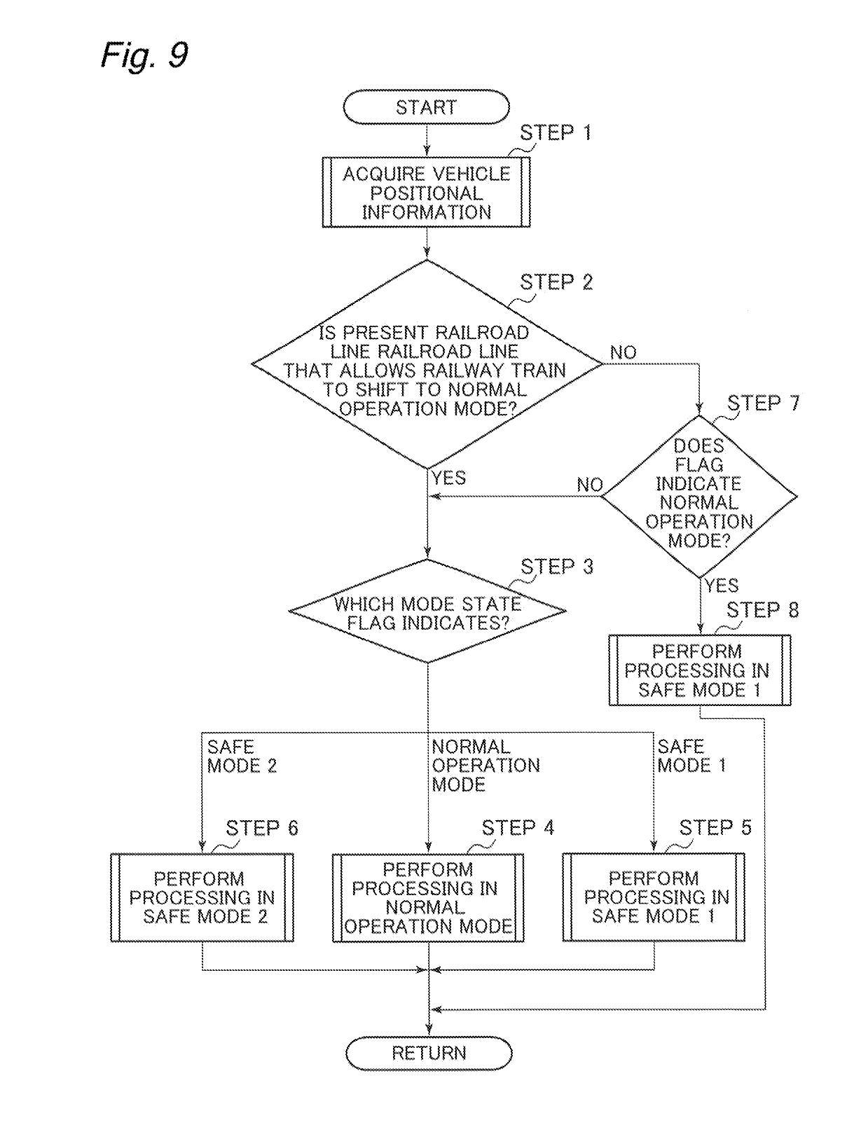

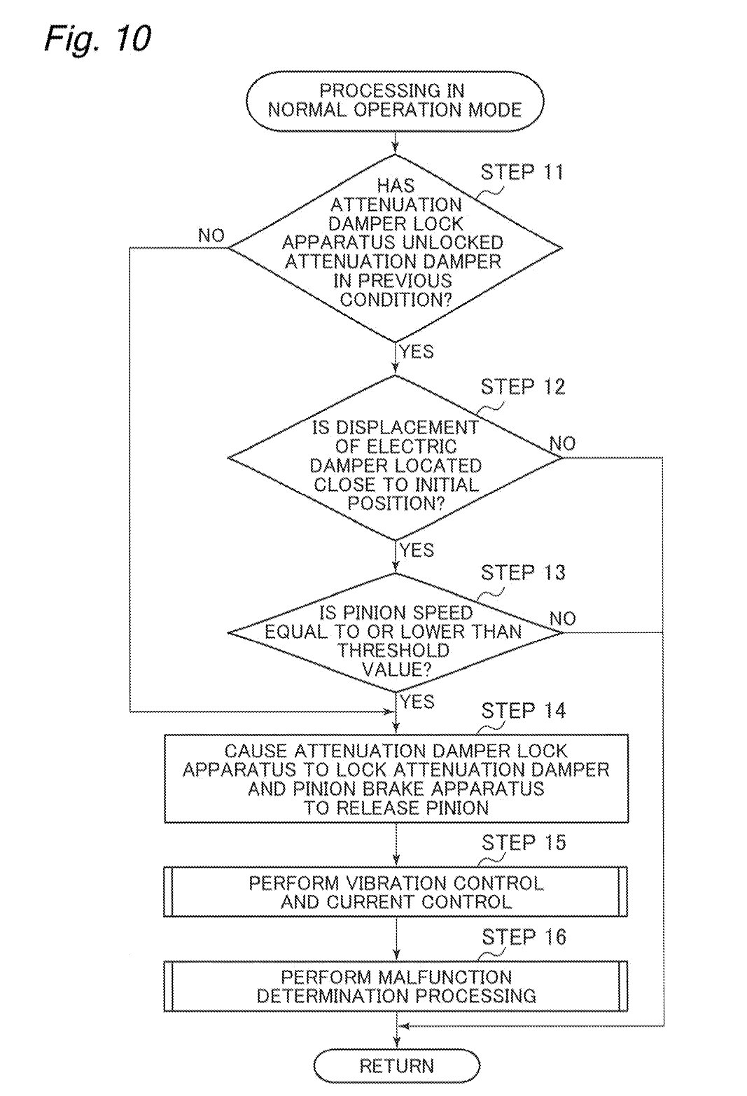

The reference numeral 23 denotes the controller including a microcomputer or the like, and this controller 23 determines an operation state, a malfunction state, and the like of the railway vehicle 1 to switch the damper apparatus 12, and adjusts the thrust force of the electric damper 14 so as to reduce a vibration of the vehicle body 2 in the left-right direction. An input side of the controller 23 is connected to the acceleration sensor 21, the pinion rotational sensor 22, the electric damper 14, and the like, and an output side of the controller 23 is connected to the electric damper 14, the attenuation damper lock apparatus 13G, the pinion brake apparatus 20, and the like. The controller 23 includes a memory (not illustrated) realized by a ROM, a RAM, or the like, and this memory stores a processing program used by a vibration control unit 29 illustrated in FIG. 8 (a processing program executed in step 15 illustrated in FIG. 10), a processing program used by a mode switching determination unit 32 illustrated in FIG. 8 (a processing program illustrated in FIGS. 9 to 14), a threshold value used in a determination about mode switching, and the like.

As illustrated in FIG. 8, the controller 23 includes a vehicle body left-right acceleration input unit 24, an electric damper displacement input unit 25, an electric damper current input unit 26, a pinion rotational angle input unit 27, a vehicle positional information acquisition unit 28, the vibration control unit 29, a current control unit 30, an electric damper current output unit 31, the mode switching determination unit 32, an attenuation damper lock apparatus signal output unit 33, a pinion brake apparatus signal output unit 34, and the like.

The vehicle body left-right acceleration input unit 24 is connected to the acceleration sensor 21, and an acceleration of the vehicle body 2 in the left-right direction is input from this acceleration sensor 21 to the vehicle body left-right acceleration input unit 24. The electric damper displacement input unit 25 is connected to the electric damper 14, and a displacement (a stroke amount or an extension/compression amount) of the movable element 14B is input from this electric damper 14 into the electric damper displacement input unit 25. The electric damper current input unit 26 is connected to a UVW line (not illustrate) of the electric damper 14, and a current value to be supplied from a current output circuit into the electric damper 14 is input into the electric damper current input unit 26. The pinion rotational angle input unit 27 is connected to the pinion rotational sensor 22, and a displacement (a rotational speed or a rotational angle) of the pinion 19 is input into the pinion rotational angle input unit 27.

The acceleration of the vehicle body 2 in the left-right direction is input from the vehicle body left-right acceleration input unit 24 into the vibration control unit 29, and the vibration control unit 29 calculates a thrust force instruction value corresponding to a force that the electric damper 14 should generated based on this acceleration. For example, the vibration control unit 29 calculates the thrust force instruction value according to the Skyhook control law, the LQG control law, H∞ control law, or the like. The current control unit 30 outputs a current instruction for controlling a current to be supplied to the electric damper 14 based on the thrust force instruction value from the vibration control unit 29, an electric angle calculated from the displacement of the electric damper 14 acquired from the electric damper displacement input unit 25, and the UVW-phase current value from the electric damper current input unit 26. The electric damper current output unit 31 actuates the current output circuit of the electric damper 14 based on the current instruction from the current control unit 30.

The mode switching determination unit 32 determines which mode should be selected as the switched state (the operation mode) of the damper apparatus 12, the normal operation mode, the safe mode 1, or the safe mode 2, based on the displacement (the rotational angle) of the pinion 19 that is acquired from the pinion rotational angle input unit 27, positional information of the vehicle 1 that is acquired from the vehicle position information acquisition unit 28, the displacement of the electric damper 14 that is acquired from the electric damper displacement input unit 25, and the current value acquired from the electric damper current input unit 26. Then, the mode switching determination unit 32 outputs a signal for locking the attenuation damper 13, a signal for unlocking the pinion 19, and the like according to the determined mode.

The attenuation damper lock apparatus signal output unit 33 outputs a lock signal (or a release signal) to the attenuation damper lock apparatus 13G based on the signal from the mode switching determination unit 32. The pinion brake apparatus signal output unit 34 outputs a brake release signal (or a brake application signal) to the pinion brake apparatus 20 based on the signal from the mode switching determination unit 32.

The damper apparatus 12 is set so as to be placed into the parallel mode (the safe mode 1) when power is not supplied to the controller 23 (when a power supply is stopped). In other words, the attenuation damper lock apparatus 13G is configured as a default unlocking apparatus that unlocks the attenuation damper 13 when power is not supplied (when the controller 23 is powered off) while locking the attenuation damper 13 when power is supplied (when a signal is input), and the pinion brake apparatus 20 is configured as a default braking apparatus that brakes the pinion 19 when power is not supplied (when the controller 23 is powered off) while releasing the pinion 19 when power is supplied (when a signal is input). Further, the electric damper 14 is placed into a free state that allows the electric damper 14 to freely extend or compress when power is not supplied (when the controller 23 is powered off). Assume that, when the electric damper 14 is set in this manner, the attenuation damper lock apparatus signal output unit 33 outputs a lock signal (supplies power) when causing the attenuation damper lock apparatus 13G to lock the attenuation damper 13, and the pinion brake apparatus signal output unit 34 outputs a brake release signal (supplies power) when causing the pinion brake apparatus 20 to release the pinion 19.

Next, a program for controlling the damper apparatus 12 that is executed by the controller 23 will be described with reference to FIGS. 9 to 14.

First, FIG. 9 illustrates processing of a main flow of the controller 23. This main flow is called by a timer interruption or the like for each cycle during which a control calculation is performed. In the main flow, first, in step 1, the controller 23 acquires the vehicle positional information by performing communication processing or the like. The information acquired by the vehicle positional information acquisition unit 28 of the controller 23 is used as this vehicle positional information. In a subsequent step, step 2, the controller 23 determines whether a present railroad line is a railroad line that allows the railway vehicle 1 to shift to the normal operation mode, i.e., the railway vehicle 1 is running on a railroad line in operation where the railway vehicle 1 transports passengers or the like, or whether the railway vehicle 1 is running on a track where an excessively large displacement may be generated between the vehicle body 2 and the bogie 5, such as a line in the rail yard, based on the vehicle positional information acquired in step 1.

If the controller 23 determines “YES”, i.e., determines that the present railroad line is a railroad line that allows the railway vehicle 1 to shift to the normal operation mode in step 2, the processing of the main flow proceeds to step 3, in which the controller 23 determines what a state flag indicates, i.e., determines which mode the present mode is. If the controller 23 determines that the state flag indicates the normal operation mode in this step, step 3, the processing of the main flow proceeds to step 4, in which the controller 23 performs processing in the normal operation mode.

If the controller 23 determines that the state flag indicates the safe mode 1 in step 3, the processing of the main flow proceeds to step 5, in which the controller 23 performs processing in the safe mode 1. The safe mode 1 executed in this step, step 5 corresponds to the safe mode 1 when the thrust force of the electric damper 14 becomes insufficient.

If the controller 23 determines that the state flag indicates the safe mode 2 in step 3, the processing of the main flow proceeds to step 6, in which the controller 23 performs processing in the safe mode 2. The safe mode 2 is the mode when the electric damper 14 is stuck (the electric damper 14 becomes unable to perform a stroke).

The state flag indicating the safe mode 1 is raised only during the processing in the normal operation mode. Further, the state flag indicating the safe mode 2 is raised only during the processing in the normal operation mode or the processing in the safe mode 1. Then, the state flag according to an initial setting (default) is set to the normal operation mode. Therefore, after the railway vehicle 1 (the controller 23) is powered on, the processing in the normal operation mode is always performed first when the railway vehicle 1 enters a railroad line that allows the railway vehicle 1 to shift to the normal operation mode.

On the other hand, if the controller 23 determines “NO”, i.e., determines that the present railroad line is not a railroad line that allows the railway vehicle 1 to shift to the normal operation mode in step 2, the processing of the main flow proceeds to step 7, in which the controller 23 determines whether the state flag indicates the normal operation mode. If the controller 23 determines “YES”, i.e., determines that the state flag indicates the normal operation mode in this step, step 7, the processing of the main flow proceeds to step 8, in which the controller 23 performs the processing in the safe mode 1. On the other hand, if the controller 23 determines “NO”, i.e., determines that the state flag does not indicates the normal operation mode in step 7, the processing of the main flow proceeds to step 3, from which the controller 23 performs subsequent processing.

Due to this flow, the railway vehicle 1 can be set into the safe mode 1 when the state flag indicates other modes than the safe mode 2, if the controller 23 determines that the present railroad line is not a railroad line that allows the railway vehicle 1 to shift to the normal operation mode (for example, the rail yard). The railway vehicle 1 is set into the safe mode 1 in this manner to, even when a large relative displacement is generated between the vehicle body 2 and the bogie 5 due to the line change in the rail yard (the railway vehicle 1 passes through a point) or the like, prevent the electric damper 14 from having a stroke amount twice this displacement.

Next, FIG. 10 illustrates the processing in the normal operation mode that is performed in step 4. In the normal operation mode, the attenuation damper lock apparatus 13G locks the attenuation damper 13, and the pinion brake apparatus 20 releases the pinion 19 to allow the damper apparatus 12 to be used in the active state. Then, in the normal operation mode, the controller 23 performs vibration control and current control of the electric damper 14, and also performs malfunction determination processing that will be described below.

More specifically, in step 11, the controller 23 determines whether the attenuation damper lock apparatus 13G unlocks the attenuation damper 13, i.e., whether the attenuation damper lock apparatus 13G has been in the releasing state in an immediately preceding control cycle. If the controller 23 determines “YES”, i.e., determines that the attenuation damper lock apparatus 13G unlocks the attenuation damper 13 in this step, step 11, the processing in the normal operation mode proceeds to step 12. In this case, when the controller 23 actuates the attenuation damper lock apparatus 13G to lock the attenuation damper 13 from such a state that the attenuation damper 13 and the electric damper 14 operates in parallel, an excessive force may be applied to the attenuation damper lock apparatus 13G, and an operation range of the electric damper 14 may be limited, depending on a stroke position and a stroke speed of the attenuation damper 13 at the timing of starting locking the attenuation damper 13.

Therefore, the following steps are performed to find an appropriate timing of actuating the attenuation damper lock apparatus 13G to lock the attenuation damper 13. First, in step 12, the controller 23 determines whether a stoke position of the electric damper 14 is located close to a stroke central position (the initial position). The information input into the electric damper displacement input unit 25 is used as the stroke position of the electric damper 34. If the controller 23 determines “NO”, i.e., determines that the stroke position of the electric damper 14 is not located close to the stroke central position in step 12, the controller 23 refrains from actuating the attenuation damper lock apparatus 13G to lock the attenuation damper 13, and the processing in the normal operation mode returns to a START step illustrated in FIG. 9 via a RETURN step illustrated in FIG. 10 and a RETURN step illustrated in FIG. 9.

On the other hand, if controller 23 determines “YES”, i.e., determines that the stroke position of the electric damper 14 is located close to the stroke central position in step 12, the processing in the normal operation mode proceeds to step 13, in which the controller 23 determines whether a rotational speed of the pinion 19 is sufficiently slow (the rotational speed is equal to or lower than a preset threshold value that allows the attenuation damper lock apparatus 13G to start locking the attenuation damper 13). If the controller 23 determines “NO”, i.e., determines that the rotational speed of the pinion 19 is not sufficiently slow (the rotational speed is fast) in this step, step 13, the controller 23 refrains from actuating the attenuation damper lock apparatus 13G to lock the attenuation damper 13, and the processing in the normal operation mode returns to the START step illustrated in FIG. 9 via the RETURN step illustrated in FIG. 10 and the RETURN step illustrated in FIG. 9.

If the controller 23 determines “YES”, i.e., determines that the rotational speed of the pinion 19 is sufficiently slow in step 13, or if the controller 23 determines “NO”, i.e., that the attenuation damper lock apparatus 13G has locked the attenuation damper 13 in step 11, the processing in the normal operation mode proceeds to step 14, in which the controller 23 actuates the attenuation damper lock apparatus 13G to lock the attenuation damper 13 (continue locking the attenuation damper 13), and causes the pinion brake apparatus 20 to release the pinion 19 (continue releasing the pinion 19). As a result, the railway vehicle 1 is placed into the active operation state illustrated in FIGS. 5(B) and 6(B) (or is maintained in the active operation state). In subsequent step, step 15, the controller 23 performs the vibration control and the current control. More specifically, in step 15, the controller 23 calculates the thrust force instruction value corresponding to the thrust force that the electric damper 14 should generate based on the predetermined control law by the vibration control unit 29, and outputs the instruction current corresponding to this thrust force to the electric damper 14 via the current control unit 30 and the electric damper current output unit 31. As a result, it becomes possible to secure a ride comfort and running stability of the vehicle. Subsequently, in step 16, the controller 23 performs the malfunction determination processing that will be described below.

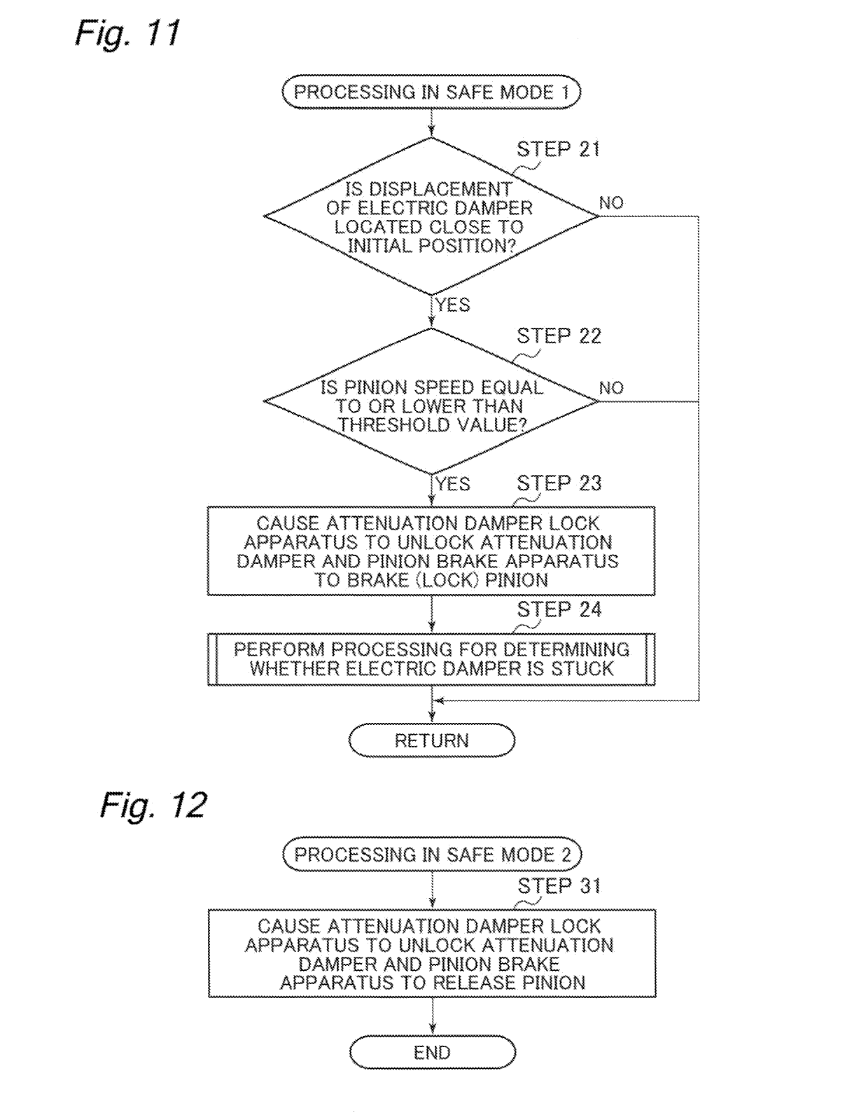

Next, FIG. 11 illustrates the processing in the safe mode 1 that is performed in step 5. In the safe mode 1, the controller 23 causes the attenuation damper lock apparatus 13G to unlock the attenuation damper 13, and the pinion brake apparatus 20 to brake (lock) the pinion 19 to allow the damper apparatus 12 to be used in the parallel state. Then, in the safe mode 1, the controller 23 performs processing for determining whether the electric damper 14 is stuck.

In this safe mode 1, when the controller 23 places the pinion brake apparatus 20 into the braking state (the locking state) from such a state that the attenuation damper 13 and the electric damper 14 are connected in series (a series connection operation), this may lead to imposition of a limitation onto the operation range of the electric damper 14 depending on a stroke position and a stroke speed of the electric damper 14 at a timing of starting locking the pinion 19. Therefore, the following steps are performed to find an appropriate timing of causing the pinion brake apparatus 20 to start braking (locking) the pinion 19. First, in step 21, the controller 23 determines whether the stroke position of the electric damper 14 is located close to the stroke central position (the initial position) of the electric damper 14 in a similar manner to step 12.

If the controller 23 determines “NO”, i.e., determines that the stroke position of the electric damper 14 is not located close to the stroke central position in step 21, the controller 23 refrains from causing the pinion brake apparatus 20 to start braking the pinion 19, and the processing in the safe mode 1 returns to the START step illustrated in FIG. 9 via a RETURN step illustrated in FIG. 11 and the RETURN step illustrated in FIG. 9. On the other hand, if the controller 23 determines “YES”, i.e., determines that the stroke position of the electric damper 14 is located close to the stroke central position in step 21, the processing in the safe mode 1 proceeds to step 22, in which the controller 23 determines whether the rotational speed of the pinion 19 is sufficiently slow (the rotational speed is equal to or lower than a preset threshold value that allows the pinion brake apparatus 20 to start braking the pinion 19).

If the controller 23 determines “NO”, i.e., determines that the rotational speed of the pinion 19 is not sufficiently slow (the rotational speed is fast) in this step, step 22, the controller 23 refrains from causing the pinion brake apparatus 20 to start braking the pinion 19, and the processing in the safe mode 1 returns to the START step illustrated in FIG. 9 via the RETURN step illustrated in FIG. 11 and the RETURN step illustrated in FIG. 9. On the other hand, if the controller 23 determines “YES”, i.e., determines that the rotational speed of the pinion 19 is sufficiently slow in step 22, the processing in the safe mode 1 proceeds to step 23, in which the controller 23 causes the attenuation damper lock apparatus 13G to unlock the attenuation damper 13 and the pinion brake apparatus 20 to brake the pinion 19. As a result, the railway vehicle 1 is placed into the parallel operation state illustrated in FIGS. 5(D) and 6(D). Then, in subsequent step, step 24, the controller 23 performs the processing for determining whether the electric damper 14 is stuck as will be described below.

Next, FIG. 12 illustrates the processing in the safe mode 2 that is performed in step 6. The safe mode 2 is the safe mode into which the railway vehicle 1 shifts when the electric damper 14 is stuck. In this safe mode 2, immediately after a shift to the processing in the safe mode 2, i.e., in step 31, the controller 23 causes the attenuation damper lock apparatus 13G to unlock the attenuation damper 13 and the pinion brake apparatus 20 to release the pinion 19 to secure the running stability of the railway vehicle 1. As a result, the railway vehicle 1 is placed into the passive operation state illustrated in FIGS. 5(C) and 6(C). In this case, for example, until the electric damper 14 is repaired in the rail yard, the railway vehicle 1 is maintained in the state of the safe mode 2.

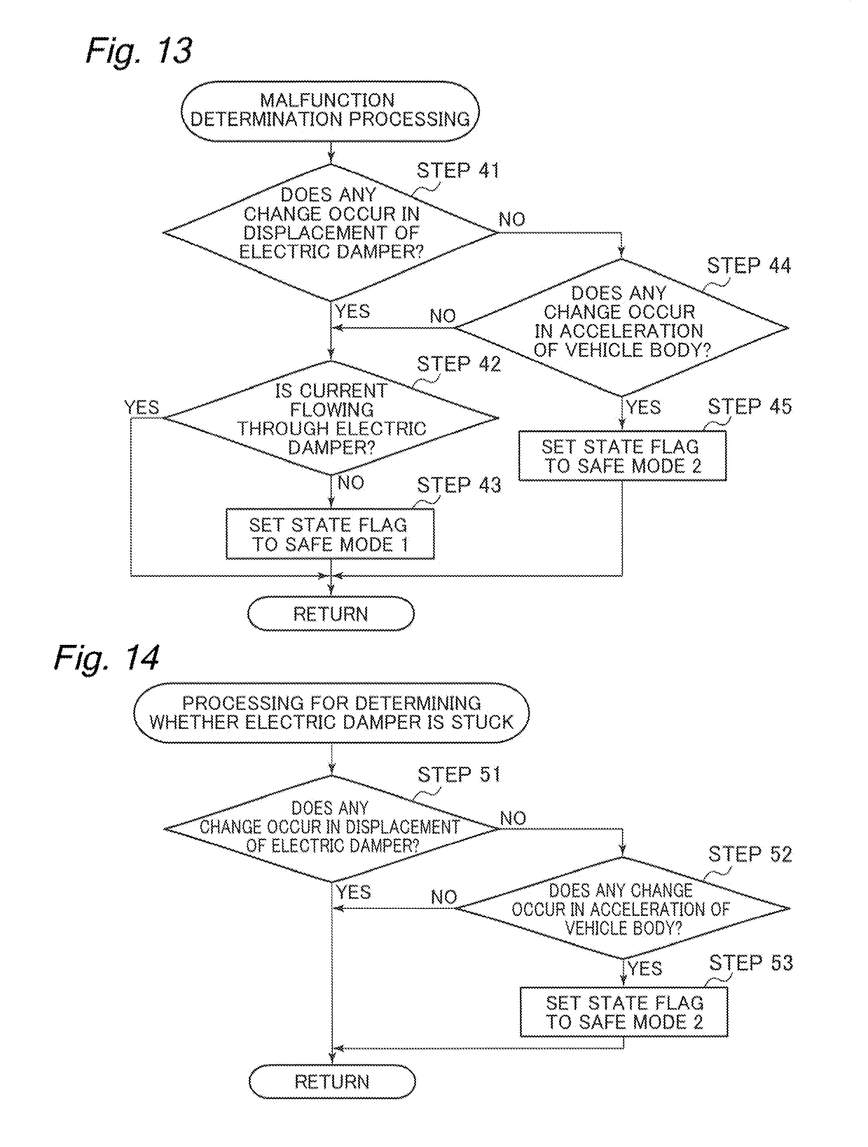

Next, FIG. 13 illustrates the malfunction determination processing that is performed in step 16. In the malfunction determination processing, the controller 23 determines a malfunction of the electric damper 14, and sets the state flag according to this malfunction.

Therefore, in step 41, the controller 23 determines whether any change occurs in the stroke of the electric damper 14. The information input into the electric damper displacement input unit 25 is used as the stroke of the electric damper 14. If the controller 23 determines “YES”, i.e., determines that a change occurs in the stroke of the electric damper 14 in step 41, the malfunction determination processing proceeds to step 42, in which the controller 23 determines whether a current is flowing through the electric damper 14. The information input into the electric damper current input unit 26 is used as the current value of the electric damper 14. If the controller 23 determines “YES”, i.e., determines that a current is flowing through the electric damper 14 according to the current instruction generated by the current control unit 30 in step 42, it is considered that there is no malfunction in the electric damper 14, whereby the malfunction determination processing returns to the START step illustrated in FIG. 9 via a RETURN step illustrated in FIG. 13 and the RETURN step illustrated in FIG. 10.

On the other hand, if the controller 23 determines “NO”, i.e., that a current is not flowing through the electric damper 14 according to the current instruction generated by the current control unit 30 (especially, the current value is insufficient) in step 42, it is considered that a current is not supplied to the electric damper 14 so that the thrust force of the electric damper 14 is insufficient. In this case, the malfunction determination processing proceeds to step 43, in which the controller 23 sets the state flag to the “safe mode 1”. Then, the malfunction determination processing proceeds to the RETURN step.

Further, if the controller 23 determines “NO”, i.e., determines that no change occurs in the stroke of the electric damper 14 in step 41, the malfunction determination processing proceeds to step 44, in which the controller 23 determines whether any (abnormal) change occurs in the acceleration of the vehicle body 2 in the left-right direction. The information input into the vehicle body left-right acceleration input unit 24 is used as the acceleration of the vehicle body 2 in the left-right direction. If the controller 23 determines “YES”, i.e., that an (abnormal) change occurs in the acceleration of the vehicle body 2 in the left-right direction in step 44, it is considered that the electric damper 14 does not perform a stroke so that the vehicle body 2 excessively vibrates, i.e., the electric damper 14 is stuck. In this case, the malfunction determination processing proceeds to step 45, in which the controller 23 sets the state flag to the “safe mode 2”. Then, the malfunction determination processing proceeds to the RETURN step. On the other hand, if the controller 23 determines “NO”, i.e., determines that no (abnormal) change occurs in the acceleration of the vehicle body 2 in the left-right direction in step 44, the malfunction determination processing proceeds to step 42, in which the controller 23 performs subsequent processing.

Next, FIG. 14 illustrates the processing for determining whether the electric damper 14 is stuck, that is performed in step 24. In the processing for determining whether the electric damper 14 is stuck, the controller 23 determines whether the electric damper 14 is stuck (or jammed), and sets the state flag according to this determination.

Therefore, in step 51, the controller 23 determines whether any change occurs in the stoke of the electric damper 14 in a similar manner to step 41. If the controller 23 determines “YES”, i.e., determines that a change occurs in the stoke of the electric damper 14 in step 51, it is considered that the electric damper 14 is not stuck, so that this processing returns to the START step illustrated in FIG. 9 via a RETURN step illustrated in FIG. 14, the RETURN step illustrated in FIG. 11, and the RETURN step illustrated in FIG. 9.

On the other hand, if the controller 23 determines “NO”, i.e., determines that no change occurs in the stroke of the electric damper 14 in step 51, this processing proceeds to step 52, in which the controller 23 determines whether any (abnormal) change occurs in the acceleration of the vehicle body 2 in the left-right direction in a similar manner to step 44. If the controller 23 determines “YES”, i.e., determines that an (abnormal) change occurs in the acceleration of the vehicle body 2 in the left-right direction in step 52, it is considered that the electric damper 14 does not perform a stroke so that the vehicle body 2 excessively vibrations. In this case, this processing proceeds to step 53, in which the controller 23 sets the state flag to the “safe mode 2”. Then this processing proceeds to the RETURN step. On the other hand, if the controller 23 determines “NO”, i.e., determines that no (abnormal) change occurs in the acceleration of the vehicle body 2 in the left-right direction in step S52, this processing proceeds to the RETURN step illustrated in FIG. 14.

In this manner, the processing illustrated in FIGS. 9 to 14 is designed in such a manner that the railway vehicle 1 is allowed to shift from the normal operation mode to any of the safe mode 1 and the safe mode 2, but is prohibited from shifting from the safe mode 1 to the normal operation mode or from the safe mode 2 to the normal operation mode (unreturnable) if the state flag is set to the safe mode 1 or the safe mode 2. Further, the processing is designed in such a manner that the railway vehicle 1 is allowed to shift from the safe mode 1 to the safe mode 2, but is prohibited from shifting from the safe mode 2 to the safe mode 1 (unreturnable). This is because the stuck (jammed) electric damper 14 in the safe mode 2 is highly necessary to be repaired in the rail yard.

The damper apparatus 12 according to the present embodiment is configured in this manner. Next, the operation thereof will be described.

First, in the normal operation mode, the attenuation damper lock apparatus 13G locks (fixes) the attenuation damper 13, while the pinion brake apparatus 20 releases (unlocks) the pinion 19, so that the railway vehicle 1 is placed in the active operation state. In this case, when the vehicle body 2 vibrates in the left-right direction, the electric damper 14 outputs a thrust force required to damp the vibration, thereby succeeding in securing the ride comfort and running stability of the vehicle.

On the other hand, when the railway vehicle 1 is running in the rail yard, or when the thrust force of the electric damper 14 is insufficient due to a stop of a power supply to the electric damper 14 or the like, the attenuation damper lock apparatus 13G unlocks the attenuation damper 13, while the pinion brake apparatus 20 locks the pinion 16, so that the railway vehicle 1 is placed into the state of the safe mode 1, i.e., the parallel operation state. In this case, when the vehicle body 2 vibrates in the left-right direction, this vibration can be damped by the attenuation damper 13 and the electric damper 14, or the attenuation damper 13 alone.

Further, when the electric damper 14 is stuck, the attenuation damper lock apparatus 13G unlocks the attenuation damper 13, and the pinion brake apparatus 20 also unlocks the pinion 19, so that the railway vehicle 1 is placed into the state of the safe mode 2, i.e., the passive operation state.

When the gear apparatus 15 constituted by the pinion 19 and the racks 17 and 18 is stuck, for example, when the pinion 19 becomes unable to rotate due to an entry of a foreign object into the portions where the pinion 19 is meshed with the racks 17 and 18 or the like, the railway vehicle 1 can be placed into the state of the safe mode 1 (the parallel operation). More specifically, when the gear apparatus 15 is stuck, the pinion 19 is prohibited (locked) from rotating by the pinion brake apparatus 20 while the attenuation damper 13 is allowed to be relatively displaced, by which a displacement between the vehicle body 2 and the bogie 5 can be absorbed by the attenuation damper 13 and the electric damper 14.

In this manner, according to the present embodiment, even with insufficiency of the thrust force of the electric damper 14 or occurrence of such a malfunction that the electric damper 14 is stuck, and further, even with occurrence of such a malfunction that the gear apparatus 15 is stuck, the railway vehicle 1 can operate in the safe mode 1 or the safe mode 2, thereby improving a fail-safe performance.

One possible measure for securing the fail-safe performance against a malfunction of a failure in a power supply that is a stop of a power supply to an electric damper during an operation is to configure a damper apparatus to include both an electric damper and an attenuation damper. However, only connecting the electric damper and the attenuation damper in parallel may lead to the attenuation damper operating so as to cancel out a force generated by the electric damper during a normal operation.

On the other hand, an electric damper including a rotation-linear motion conversion mechanism (a reducer mechanism) using a ball screw or a roller screw can prevent the damping force from becoming zero at a malfunction of a failure in a power supply, because, for example, a resistance for rotating an electric motor via the reducer mechanism serves as the damping force. However, without any measure taken, the ride comfort and the running stability may be reduced, for example, when the reducer mechanism is stuck. Therefore, a possible solution therefor is to configure a damper apparatus to include an attenuation damper mounted in series with the electric damper having the rotation-linear motion conversion mechanism (the reducer mechanism). However, in this case, the attenuation damper may absorb a displacement of the electric damper.

On the other hand, according to the present embodiment, the damper apparatus 12 can generate a desired force according to a condition (an operation condition or a malfunction condition) at that time regardless of the operation condition and whether the electric damper 14 and the gear apparatus 15 are normal or abnormal. More specifically, the damper apparatus 12 according to the present embodiment can switch the attenuation damper 13 and the electric damper 14 between the series connection and the parallel connection with use of the gear apparatus 15.

Therefore, the damper apparatus 12 can generate the desired force with use of one or both of the attenuation damper 13 and the electric damper 14 according to the operation condition and the malfunction condition. More specifically, for example, the damper apparatus 12 can mechanically connect the attenuation damper 13 and the electric damper 14 in series by causing the pinion brake apparatus 20 to unlock the pinion 19. In this case, the electric damper 14 can be used alone by causing the attenuation damper lock apparatus 13G to lock the attenuation damper 13. Further, for example, the attenuation damper 13 and the electric damper 14 can be connected in parallel by causing the pinion brake apparatus 20 to lock the pinion 19 (and also causing the attenuation damper lock apparatus 13G to unlock the attenuation damper 13). In this case, a force can be acquired from both of the attenuation damper 13 and the electric damper 14 (from the attenuation damper 13 at the time of a failure in a power supply to the electric damper 14).

According to the present embodiment, the gear apparatus 15 as the switching unit is constituted by the racks 17 and 18 and the pinion 19, whereby the force can be stably transmitted via the gear apparatus 15 in any switched states (the operation modes) of the series connection and the parallel connection.

According to the present embodiment, the frictional force of the gear of the pinion 19 can be changed by the pinion brake apparatus 20, whereby, for example, the switched state can be switched to the series connection (the normal operation mode or the safe mode 2) by setting the frictional force to zero (allowing the pinion 19 to rotate freely). On the other hand, the switched state can be switched to the parallel connection (the safe mode 1) by maximizing the frictional force (prohibiting the pinion 19 from rotating).

According to the present embodiment, the damper apparatus 12 as the force generation mechanism is configured to be used as the left-right movement damper mounted between the vehicle body 2 and the bogie 5, whereby the damper apparatus 12 can stably generate the described force according to the operation condition and the malfunction condition between the vehicle body 2 and the bogie 5 to improve the performance of the railway vehicle 1.

According to the present embodiment, the damper apparatus 12 is configured in such a manner that the stator 14A of the electric damper 14 and the cylinder 13A of the attenuation damper 13 are mounted on the bogie 5 while the movable element 14B of the electric damper 34 and the rod 13B of the attenuation damper 13 are mounted on the racks 17 and 18, respectively, and the pinion 19 is further mounted on the vehicle body 2 with the respective racks 17 and 18 meshed therewith so as to sandwich the pinion 19 from a radial direction. Then, the damper apparatus 12 is configured so as to include the attenuation damper lock apparatus 13G that prohibits a relative displacement between the cylinder 13A and the rod 13B of the attenuation damper 13, and the pinion brake apparatus 20 that prohibits a rotation of the pinion 19.

Therefore, when the railway vehicle 1 operates normally (when the railway vehicle 1 is normal), the damper apparatus 12 refrains from prohibiting a rotation of the pinion 19 while prohibiting a relative displacement (extension/compression) of the attenuation damper 13 by the attenuation damper lock apparatus 13G, thereby succeeding in transmitting a whole output of the electric damper 14 to the vehicle body 2 via the rack 17 and the pinion 19. In other words, when the railway vehicle 1 operates normally, it is possible to prevent the force generated by the electric damper 14 from being absorbed by the attenuation damper 13 to secure the performance of the damper apparatus 12 as a whole.

Further, when the railway vehicle 1 operates normally, the force generated by the electric damper 14 is transmitted to the vehicle body side via the rack 17 and the pinion 19, whereby the force generated by the electric damper 14 can be transmitted to the vehicle body side while boosting it. As a result, even if the electric damper 14 is realized by an electric damper that generates a weak force, it is possible to increase the force generated by the damper apparatus 12 as a whole.

On the other hand, when some malfunction occurs, for example, when the damping force of the electric damper 14 is insufficient due to a failure in a power supply or the like, the damper apparatus 12 prohibits a rotation of the pinion 19 by the pinion brake apparatus 20 while allowing a relative displacement of the attenuation damper 13, thereby succeeding in absorbing a displacement between vehicle body 2 and the bogie 5 by the attenuation damper 13. As a result, it is possible to prevent the damper apparatus 12 from becoming unable to generate any damping force as a whole, whereby it is possible to improve the fail-safe performance and the reliability of the damper apparatus 12.

Further, when the electric damper 14 is stuck, the damper apparatus 12 allows a rotation of the pinion 19 and a relative displacement of the attenuation damper 13, thereby succeeding in absorbing a displacement between the vehicle body 2 and the bogie 5 by the attenuation damper 13. Therefore, it is also possible to improve the fail-safe performance and secure the reliability of the damper apparatus 12 in terms thereof.

Further, when the gear apparatus 15 constituted by the pinion 19 and the racks 17 and 18 is stuck, for example, when the pinion 19 becomes unable to rotate due to an entry of a foreign object into the portions where the pinion 19 is meshed with the racks 17 and 18, or the like, the damper apparatus 12 prohibits a rotation of the pinion 19 by the pinion brake apparatus 20 while allowing a relative displacement of the attenuation damper 13, thereby succeeding in absorbing a displacement between the vehicle body 2 and the bogie 5 by the attenuation damper 13 and the electric damper 14. In this case, the damper apparatus 12 can generate a force as the damper apparatus 12 in which the attenuation damper 13 and the electric damper 14 are connected in parallel. Therefore, it is also possible to improve the fail-safe performance and secure the reliability of the damper apparatus 12 in terms thereof.

The above-described first embodiment has been described based on the example configured in such a manner that the stator 14A and the movable element 14B of the electric damper 14 are provided (mounted) on the bogie 5 and the rack 17, respectively, while the cylinder 13A and the rod 13B of the attenuation damper 13 are provided (mounted) on the bogie 5 and the rack 18, respectively. However, the first embodiment is not limited thereto, and may be configured in such a manner that, for example, the movable element and the stator of the electric damper are (provided) mounted on the bogie side and rack, respectively, while the rod and the cylinder of the attenuation damper are (provided) mounted on the bogie side and rack, respectively. In other words, the first embodiment can be configured in such a manner that any one of the stator and movable element of the electric damper is mounted on one member (or the other member) and the other of the stator and the movable element is provided (mounted) on the rack, while one of the cylinder and the rod of the attenuation damper is mounted on the one member (or the other member) and the other of the cylinder and the rod is provided (mounted) on the rack.

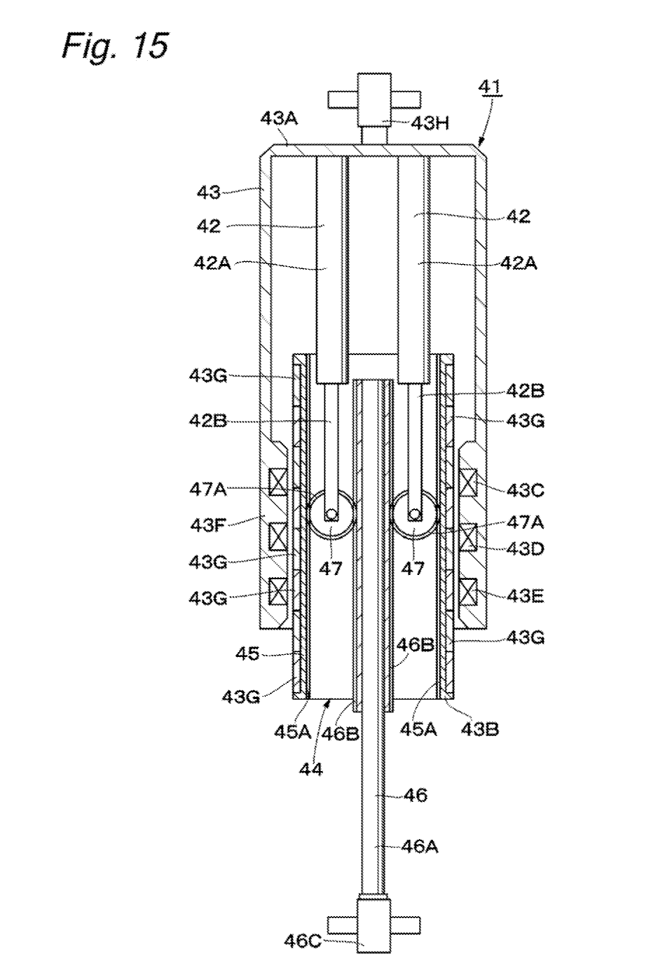

Next, FIGS. 15 and 16(A) to (D) illustrate a second embodiment of the present invention. The above-described first embodiment is configured to include the racks on the respective electric damper side and attenuation damper side, and also include the pinion on the vehicle body side. On the other hand, the present embodiment is configured to include the racks on the respective electric damper side and the bogie side, and also include the pinion on the attenuation damper side. In the following description of the present embodiment, similar components to the above-described first embodiment will be identified by the same reference numerals as the first embodiment, and descriptions thereof will be omitted.

A damper apparatus 41 according to the present embodiment is mounted between the two members, the vehicle body 2 as the one of the relatively moving members, and the bogie 5 as the other of the relatively moving members. The damper apparatus 41 generally includes a pair of attenuation dampers 42 as the force generation unit, an electric damper 43 as the force generation unit, and a gear apparatus 44 as the switching unit.

Each of the attenuation dampers 42 includes a rod 42B protruding from a cylinder 42A, and generates a damping force by converting motion energy of a forward or backward movement of this rod 42B into heat energy, in a similar manner to the attenuation damper 13 according to the above-described first embodiment. A proximal end of the cylinder 42A, which corresponds to a bottom side of each of the attenuation dampers 42, is attached inside a stator 43A of the electric damper 43 that will be described below. On the other hand, a pinion 47 included in the gear apparatus 44 that will be described below is disposed at a distal end of the rod 42B, which corresponds to a rod side of each of the attenuation dampers 42.

Further, an attenuation damper lock apparatus 42C (refer to FIGS. 16(A) to (D)), which prohibits (forbids) a relative movement between the cylinder 42A and the rod 42B (a forward or backward movement of the rod 42B relative to the cylinder 42A), is disposed at the attenuation damper 42. This attenuation damper lock apparatus 42C is similar to the attenuation damper lock apparatus 13G according to the above-described first embodiment, and can employ, for example, a configuration that realizes the locking state by prohibiting (blocking) a flow of hydraulic fluid in the cylinder 42A.

The electric damper 43 includes the stator 43A and a movable element 43B linearly movable relative to the stator 43A in a similar manner to the electric damper 14 according to the above-described first embodiment. In other words, the electric damper 43 is configured as a three-phase linear synchronous motor, and generally includes the bottomed cylindrical stator 43A including an armature 43F with coils 43C, 43D, and 43E of U, V, and W phases provided thereon, and the cylindrical movable element 43B including a plurality of cylindrical permanent magnets 43G arranged side by side in an axial direction.

A mounting eye 43H for mounting a proximal end of the stator 43A onto the vehicle body side is provided at the proximal end of the stator 43A. On the other hand, a rack 45 included in the gear apparatus 44 that will be described below is provided on a radially inner side of the movable element 43B. Further, for example, a guide pin (not illustrated), which is slidable relative to the movable element 43B at a position that prevents interference with the permanent magnets 43G and a tooth portion 45A of the rack 45, is disposed at the stator 43A to allow the movable element 43B and the stator 43A to have a relative displacement (extension/compression) therebetween while being kept coaxial with each other.

Further, an electric damper lock apparatus 43J (refer to FIGS. 16(A) to (D)), which prohibits (forbids) a relative movement between the stator 43A and the movable element 43B (a forward or backward movement of the movable element 43B relative to the stator 43A), is disposed at the electric damper 43. This electric damper lock apparatus 43J can be configured similarly to the electric damper lock apparatus provided in the above-described first embodiment as necessary. For example, the electric damper lock apparatus 43J can be configured to be disposed at, for example, the above-described guide pin, and to fix the movable element 43B to the guide pin when locking the electric damper.

The gear apparatus 44 is disposed between the attenuation damper 42 and the electric damper 43. The gear apparatus 44 allows the attenuation damper 42 and the electric damper 43 to be mechanically switched between the series connection and the parallel connection. Therefore, the gear apparatus 44 generally includes the rack (rack gear) 45 that is one rack, a rack (rack gear) 46 that is the other rack, and the pinions (pinion gears) 47 and 47. The one rack 45 and the other rack 46 are disposed opposite of the pinion 47 from each other.

The one rack 45 is integrally formed at the movable element 43B of the electric damper 43. In other words, the one rack 45 is constructed by forming the tooth portion 45A configured to be meshed with the pinion 47 inside the movable element 43B of the electric damper 43 in a length direction (the axial direction) in such a manner that the pinion 47 and the tooth portion 45A face each other.

The other rack 46 includes a rod-like rod member 46A, and a tooth portion 46B provided on a one-end side of the rod member 46A so as to extend in the length direction (the axial direction) and configured to be meshed with the pinion 47. Then, a mounting eye 46C for mounting the other rack 46 onto the bogie side is provided on a proximal end of the rod member 46A. For example, a bearing (not illustrated) for positioning the rod member 46A (fixing a position of a center) is disposed between the rod member 46A, and the stator 43A and the attenuation damper 42 so as to allow the rod member 46A (the other rack 46) and the stator 43A of the electric damper 43 to have a relative displacement (extension/compression) therebetween while being kept coaxial with each other.

The pinions 47 and 47 are formed as annular members including the tooth portions 47A configured to be meshed with the racks 45 and 46 on outer circumferential sides thereof, and are attached to the distal ends of the rods 42B of the attenuation damper 42, respectively. In this case, the respective pinions 47 are rotatably attached to the distal ends of the rods 42B via rolling bearings (not illustrated). Axes of the respective pinions 47 as rotational centers are perpendicular to a central axis of the rod 42B.

The gear apparatus 44 can be configured in such a manner that a pinion brake apparatus is provided so as to vary frictional forces of gears of the pinions 47 (prohibit rotations of the pinions 47) as necessary. This pinion brake apparatus can be configured similarly to the pinion brake apparatus 20 according to the above-described first embodiment. The pinion brake apparatus can create a state illustrated in FIG. 16(D) that will be described below, i.e., a state similar to such a state that the racks 45 and 46 and the pinions 47 of the gear apparatus 44 are fixed (stuck) to each other

Next, an operation principle of the damper apparatus 41 will be described with reference to FIGS. 16(A) to (D). FIGS. 16(A) to (D) illustrate the damper apparatus 41 as if it is configured to include only the single attenuation damper 42, and the single pinion 47 meshed with the racks 45 and 46 for facilitating better understanding of operations of the respective consistent members of the damper apparatus 41. Further, a black triangle X1 illustrated in FIG. 16(B) indicates that the rod 42B is locked (fixed) by the attenuation damper lock apparatus 42C. A black triangle X2 illustrated in FIG. 16(C) indicates that the movable element 43B is locked (fixed) by the electric damper lock apparatus 43J. A black triangle X3 illustrated in FIG. 16(D) indicates that a rotation of the pinion 47 is locked (stuck or fixed) due to a malfunction of the damper apparatus 41 or by the pinion brake apparatus provided as necessary.

FIG. 16(A) illustrates the neutral state (the neutral position and the initial position). This case corresponds to, for example, such a state that all of the attenuation damper lock apparatus 42C, the electric damper lock apparatus 43J, and the pinion brake apparatus provided as necessary unlock (or lock) the respective their targets.

FIG. 16(B) indicates the active operation in which the attenuation damper lock apparatus 42C locks (fixes) the attenuation damper, while the electric damper lock apparatus 43J (and the pinion brake apparatus provided as necessary) unlocks the electric damper (and the pinion). In this state, a relative displacement between the cylinder 42A and the rod 42B of the attenuation damper 42 is limited (prohibited), while a relative displacement between the stator 43A and the movable element 43B of the electric damper 43 and a rotation of the pinion 47 are not limited (not prohibited).

In this case, when the rack 46 on the bogie side is displaced (vibrates) together with the bogie 5 in the left-right direction (a vertical direction in FIGS. 16(A) to (D)) of the vehicle body 2 due to an input from the bogie side, the movable element 43B of the electric damper 43 is displaced by the same displacement amount as a displacement amount of the rack 46 in a reverse direction of a displacement direction of the rack 46 via a rotation of the pinion 47 since a displacement of the rod 42B of the attenuation damper 42 is limited. At this time, the attenuation damper 42 is locked so that the attenuation damper 42 does not function so as to cancel out the movement of the electric damper 43 (does not interfere with the movement of the electric damper 43). Therefore, an entire force generated by the electric damper 43 is transmitted to the rack 46 on the bogie side (as the vibration damping force). This active operation state can be used as a mode when the electric damper 43 is determined to have no malfunction (the normal operation mode). In this case, the ride comfort can be controlled by the electric damper 43.

FIG. 6(C) illustrates the passive operation in which the attenuation damper lock apparatus 42C (and the pinion brake apparatus provided as necessary) unlocks the attenuation damper (and the pinion), while the electric damper lock apparatus 43J locks (fixes) the electric damper 43. In this state, a relative displacement between the stator 43A and the movable element 43B of the electric damper 43 is limited (prohibited), while a relative displacement between the cylinder 42A and the rod 42B of the attenuation damper 42, and a rotation of the pinion 47 are not limited (not prohibited).

In this case, when the rack 46 on the bogie side is displaced (vibrates) together with the bogie 5 in the left-right direction (the vertical direction in FIGS. 16(A) to (D)) of the bogie 5 due to an input from the bogie side, the pinion 47 is displaced by a displacement amount half (½) a displacement amount of the rack 46 in the same direction as the displacement of the rack 46 while rotating since a displacement of the movable element 43B of the electric damper 43 is limited. As a result, the rod 42B of the attenuation damper 42 is displaced by the displacement amount half (½) the displacement amount of the rack 46 in the same direction as the displacement of the rack 46 (the bogie 5).

At this time, the electric damper 43 is locked and therefore does not work, whereby an entire work input from the rack 46 on the bogie side is absorbed by the attenuation damper 42. In this case, a speed reduction mechanism (a reducer) is constructed between the pinion 47 and the racks 45 and 46, whereby the attenuation damper 42 is displaced by the amount half (½) the displacement of the rack 46 on the bogie side, and a half of a force generated by the attenuation damper 42 is transmitted to the rack 46 on the bogie side. Therefore, the attenuation damper 42 included in the damper apparatus 41 according to the present embodiment can generate a damping force equivalent to the attenuation damper used alone by having a damping coefficient four times as large as the conventional attenuation damper used alone.

This passive operation state can be used as a mode when the electric damper 43 is determined to have a malfunction (the safe mode). In this case, the ride comfort can be secured by the attenuation damper 42. The active operation state and the passive operation state can be switched according to a malfunction of the electric damper 43, and for example, can be further switched arbitrarily (when necessary) even when the electric damper 43 does not have a malfunction, i.e., when the railway vehicle operates normally.

FIG. 16(D) illustrates the parallel operation in which the attenuation damper lock apparatus 42C and the electric damper lock apparatus 43J unlock the attenuation damper and the electric damper, respectively, while a rotation of the pinion 47 is locked (stuck or fixed) due to a malfunction of the gear apparatus 44 or by the pinion brake apparatus provided as necessary. In this state, a rotation of the pinion 47 is limited (prohibited), while a relative displacement between the stator 43A and the movable element 43B of the electric damper 43, and a relative displacement between the cylinder 42A and the rod 42B of the attenuation damper 42 are not limited.

In this case, the movable element 43B of the electric damper 43 and the rod 42B of the attenuation damper 42 are displaced by the same amounts in the same direction as a displacement of the rack 46 on the bogie side. As a result, even when the gear apparatus 44 is stuck, the rack 46 on the bogie sie can be displaced (performs a stroke), which improves the fail-safe performance and the reliability. If the attenuation damper 42 has a damping coefficient four times as large as the conventional damper used alone as described above to secure the damping force of the damper apparatus 41 as a whole during the passive operation, the damper apparatus 41 is four times as rigid as the conventional damper used alone when the force generated by the electric damper 43 is zero during the parallel operation.

In this manner, the thus-configured second embodiment can also acquire a generally similar effect to the above-described first embodiment. In other words, the present embodiment can also generate a desired force according to a condition at that time regardless of an operation condition and whether the electric damper 43 and the gear apparatus 44 are normal or abnormal.

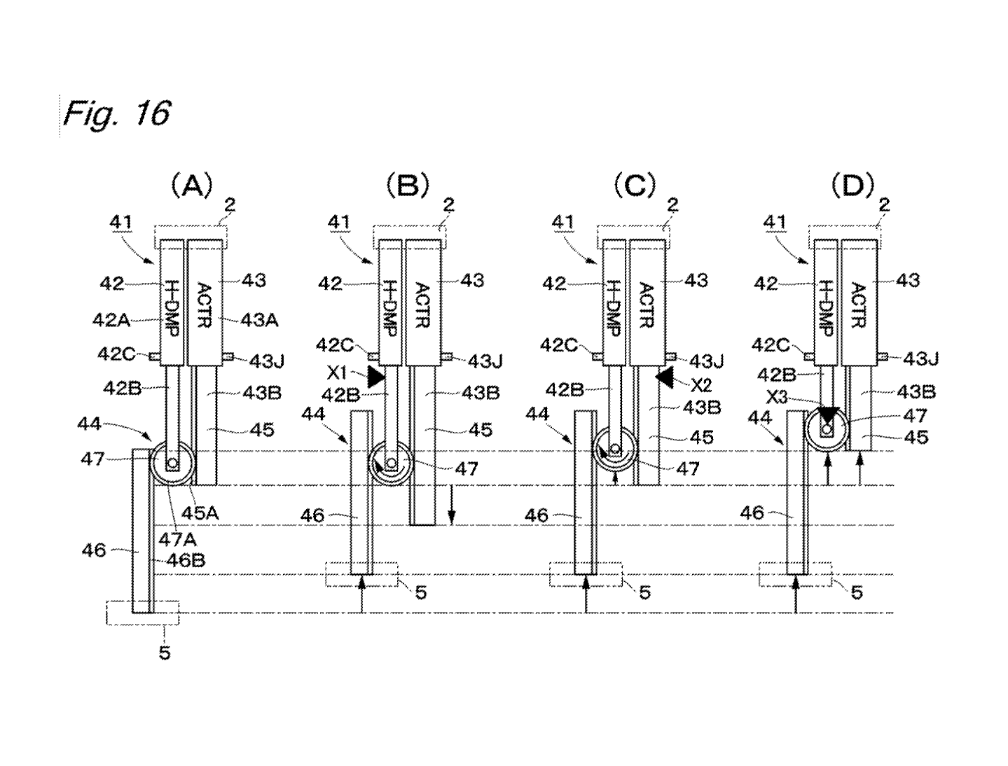

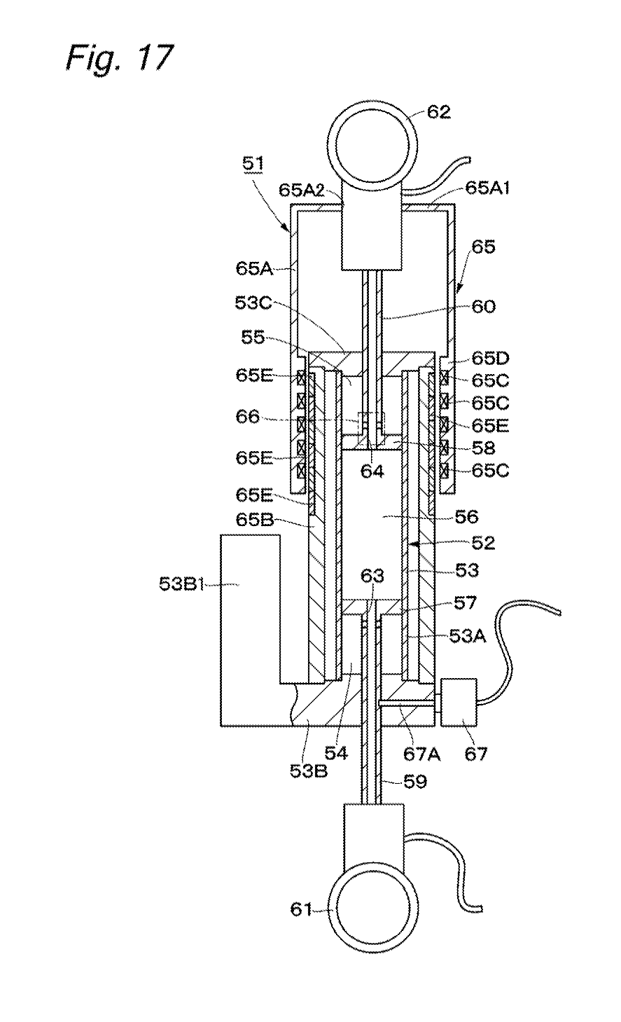

Next, FIG. 17 illustrates a third embodiment of the present invention. According to the above-described first and second embodiments, the switching unit is realized by the gear apparatus including the racks and the pinion. On the other hand, according to the present embodiment, the switching unit is realized by a flow amount adjustment apparatus that adjusts a flow amount of the hydraulic fluid, and an attenuation damper lock apparatus that prohibits (forbids) an extension/compression of the attenuation damper. In the following description of the present embodiment, similar components to the above-described first embodiment will be identified by the same reference numerals as the first embodiment, and descriptions thereof will be omitted.

A damper apparatus 51 according to the present embodiment generally includes an attenuation damper 52 as the force generation unit, an electric damper 65 as the force generation unit, and a flow amount adjustment apparatus 66 and an attenuation damper lock apparatus 67 as the switching unit.

The attenuation damper 52 includes a pair of rods 59 and 60 protruding from a cylinder 53, and generates a damping force by converting motion energy of forward or backward movements of the rods 59 and 60 into heat energy. More specifically, the attenuation damper 52 includes the cylindrical cylinder 53 sealingly containing the hydraulic fluid such as the hydraulic oil, a first piston 57 and a second piston 58 diplaceably contained in the cylinder 53 and defining the inside of the cylinder 53 into three chambers, a first rod-side oil chamber 54, a second rod-side oil chamber 55, and an intermediate oil chamber 56, the first rod 59 having a one-end side protruding from one end of the cylinder 53 and an opposite-end side fixedly attached to the first piston 57, and the second rod 60 having a one-end side protruding from an opposite end of the cylinder 53 and an opposite-end side fixedly attached to the second piston 58.

The cylinder 53 includes a cylindrical cylinder main body 53A, and a first cover member 53B and a second cover member 53C closing respective openings of the cylinder main body 53A on both end sides in an axial direction together with respective openings of a movable element 65B of the electric damper 65 that will be described below on both end sides in the axial direction, respectively. A reservoir 53B1, which contains the hydraulic fluid, is provided at the first cover member 53B. Further, the attenuation damper lock apparatus 67 that will be described below is disposed at the first cover member 53B.

Further, a first mounting eye 61 configured to be mounted on the vehicle body side or the bogie side is provided at one end of the first rod 59, and a second mounting eye 62 configured to be mounted on the bogie side or the vehicle body side is provided at one end of the second rod 60. The second mounting eye 62 protrudes from a bottom portion 65A1 of a stator 65A of the electric damper 65 that will be described below. In other words, the second rod 60 and the stator 65A are fixed to the second mounting eye 62, and these second rod 60 and stator 65A are configured to be integrally displaced with each other.

Further, a first oil passage 63, which connects the first rod-side oil chamber 54 and the intermediate oil chamber 56 to each other to allow the hydraulic oil to flow between these first rod-side oil chamber 54 and intermediate oil chamber 56, is formed at the first piston 57 and the first rod 59. A second oil passage 64, which connects the second rod-side oil chamber 55 and the intermediate oil chamber 56 to each other to allow the hydraulic oil to flow between these second rod-side oil chamber 55 and intermediate oil chamber 56, is formed at the second piston 58 and the second rod 60.

A damping force generation mechanism (not illustrated) such as an orifice serving as a resistance against a flow of the hydraulic fluid is provided at an intermediate position of the first oil passage 63. This damping force generation mechanism restrains a flow of the fluid between the first rod-side oil chamber 54 and the intermediate oil chamber 56, thereby generating a damping force between the first rod 59 and the cylinder 53. On the other hand, the flow amount adjustment apparatus 66 that will be described below is provided in the second oil passage 64.

The electric damper 65 includes the stator 65A, and the movable element 65B linearly movable relative to the stator 65A. In other words, the electric damper 65 is configured as a linear motor, and generally includes the bottomed cylindrical stator 65A including an armature 65D with coils 65C provided thereon, and the cylindrical movable element 65B including a plurality of cylindrical permanent magnets 65E arranged side by side in the axial direction.

An attachment hole 65A2 for attaching the second mounting eye 62 provided at the second rod 60 is formed at the bottom portion 65A1 of the stator 65A. Due to this hole, the stator 65A and the second rod 60 are mounted on the vehicle body side or the bogie side via the second mounting eye 62, which is a common mounting eye. On the other hand, the movable element 65B is attached to the cylinder 53 on a radially outer side of the cylinder 53 of the attenuation damper 52. More specifically, the movable element 65B is attached to the cylinder 53 with the cylinder 53 inserted therein and the openings of the movable element 65B on the both sides in the axial direction closed by the cover members 53B and 53C of the cylinder 53.

The flow amount adjustment apparatus 66 constitutes the switching unit together with the attenuation damper lock apparatus 67 that will be described below, and allows the attenuation damper 52 and the electric damper 65 to be switched between the series connection and the parallel connection. The flow amount adjustment apparatus 66 is disposed at a certain position of the oil passage 64 between the attenuation damper 52 and the electric damper 65. The flow amount adjustment apparatus 66 increases or reduces an opening area of the second oil passage 64 through which the hydraulic fluid passes, and is switched among, for example, a fully opened state in which the opening area is maximized, a completely closed state in which the opening area is zero, and an opening area reduction state as an intermediate state between them (a state between the fully opened state and the completely closed state).

The attenuation damper lock apparatus 67 is located between the attenuation damper 52 and the electric damper 65 and is attached to the first cover member 53B. The attenuation damper lock apparatus 67 prohibits (forbids) a relative movement between the cylinder 53 and the first rod 59 (a forward or backward movement of the first rod 59 relative to the cylinder 53). The attenuation damper lock apparatus 67 includes an engagement pin 67A configured to be engaged with the first rod 59, and prohibits a relative movement between the cylinder 53 and the first rod 59 by engaging the engagement pin 67A with the first rod 59 when locking the attenuation damper 52. On the other hand, the attenuation damper lock apparatus 67 disengages the engagement pin 67A from the first rod 59 by retracting the engagement pin 67A from the first rod 59 when unlocking the attenuation damper 52. As a result, the first rod 59 is allowed to move relative to the cylinder 53.

Next, an operation of the damper apparatus 51 according to the present embodiment will be described.

When the flow amount adjustment apparatus 66 is in the fully opened state, the hydraulic fluid smoothly flows between the second rod-side oil chamber 55 and the intermediate oil chamber 56, and the second rod 60 can be freely displaced relative to the cylinder 53. In this case, the railway vehicle can be placed into the active operation using the electric damper 65 alone, by causing the attenuation damper lock apparatus 67 to lock the attenuation damper (to prohibit the first rod 59 from being displaced relative to the cylinder 53), thereby

On the other hand, when the flow amount adjustment apparatus 66 is in the completely closed state, the hydraulic fluid is blocked (prohibited) from flowing between the second rod-side oil chamber 55 and the intermediate oil chamber 56, thereby prohibiting (forbidding) the second rod 60 from being displaced relative to the cylinder 53. In this case, a damping force can be generated between the cylinder 53 and the first rod 59 by causing the attenuation damper lock apparatus 67 to unlock the attenuation damper 52 (allow the first rod 59 to be displaced relative to the cylinder 53). As a result, the railway vehicle can be placed into the passive operation (the series connection) using the attenuation damper 52 alone.

On the other hand, when the flow amount adjustment apparatus 66 is in the opening area reduction state, the flow of the hydraulic fluid can be restrained between the second rod-side oil chamber 55 and the intermediate oil chamber 56, and a damping force can be generated between the second rod 60 and the cylinder 53. In other words, the flow amount adjustment apparatus 66 functions as a damping force generation mechanism that generates a damping force between the second rod 60 and the cylinder 53. In this case, the railway vehicle can be placed into the parallel operation state (the parallel connection) in which the attenuation damper 52 and the electric damper 65 can operate in parallel by causing the attenuation damper lock apparatus 67 to lock the attenuation damper 52.

In this manner, the thus-configured third embodiment can also acquire a similar effect to the above-described first and second embodiments. In other words, the present embodiment can also generate a desired force according to a condition at that time regardless of an operation condition and whether the electric damper 65 is normal or abnormal.

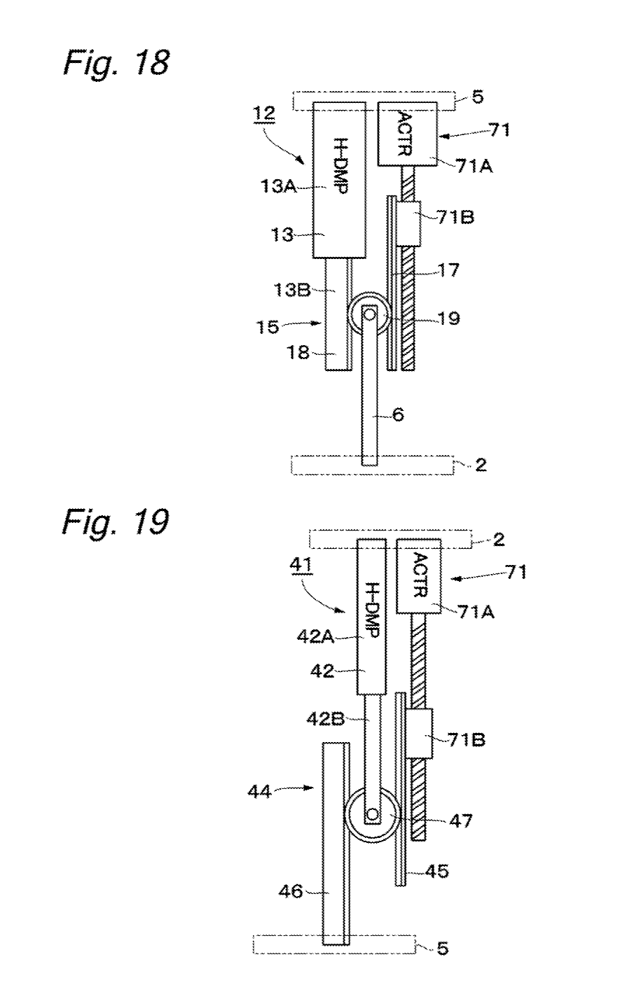

The above-described first and second embodiments have been described based on the example in which the electric damper 14 or 43 is realized by the direct-drive linear motor. However, the present invention is not limited thereto. For example, an electric damper 71 may include a rotational motor 71A including a stator, and a rotation-linear motion conversion mechanism 71B (a ball screw mechanism or the like) including a movable element, like a first modification illustrated in FIG. 18 and a second modification illustrated in FIG. 19. In this case, FIG. 18 corresponds to a modification of the first embodiment, and FIG. 19 corresponds to a modification of the second embodiment.

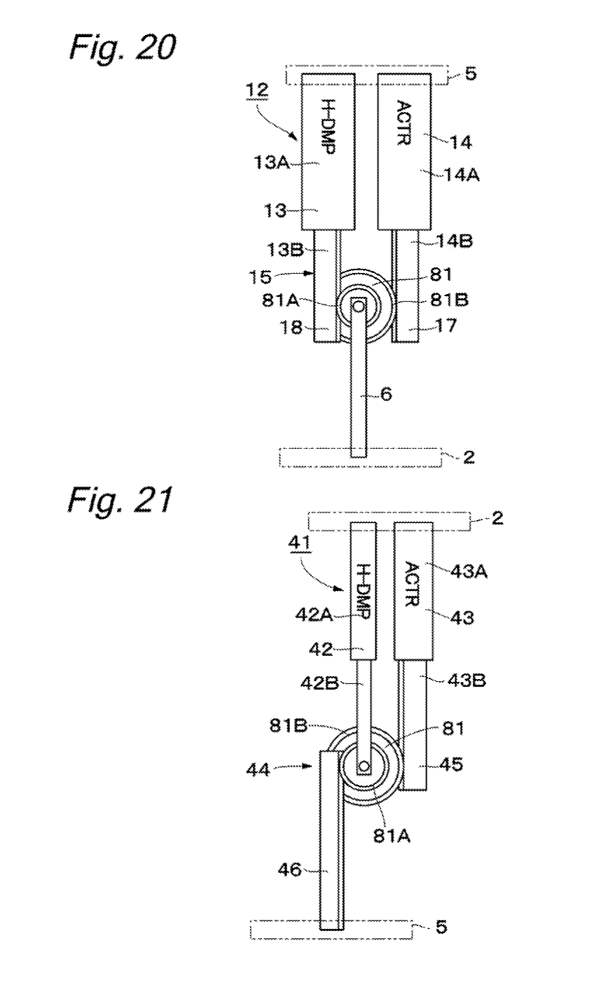

The above-described first and second embodiments have been described based on the example in which the gear apparatus 15 or 44 is configured in such a manner that the pair of racks 17 and 18 or the pair of racks 45 and 46 are meshed with the pinion 19 or 47 including the single tooth portion 19A or 47A. However, the present invention is not limited thereto. For example, a pinion 81 may be configured to include tooth portions 81A and 81B having different outer diameters from each other and the racks 17 and 18 or 45 and 46 are configured to be meshed with the respective tooth portions 81A and 81B, like a third modification illustrated in FIG. 20 and a fourth modification illustrated in FIG. 21. FIG. 20 corresponds to a modification of the first embodiment, and FIG. 21 corresponds to a modification of the second embodiment.

In this case, a relationship among the displacement amounts of the racks 17 and 18 or 45 and 46 and the displacement amount of the pinion 81 is determined from a ratio of the diameters of the respective tooth portions 81A and 81B of the pinion 81. Therefore, the electric damper (the electric actuator) 14 or 43 can be an electric damper of a low-speed high torque or a high-speed low torque according to a setting of the ratio between the diameters of the respective tooth portions 81A and 81B of the pinion 81, whereby the flexibility of the design can be improved.

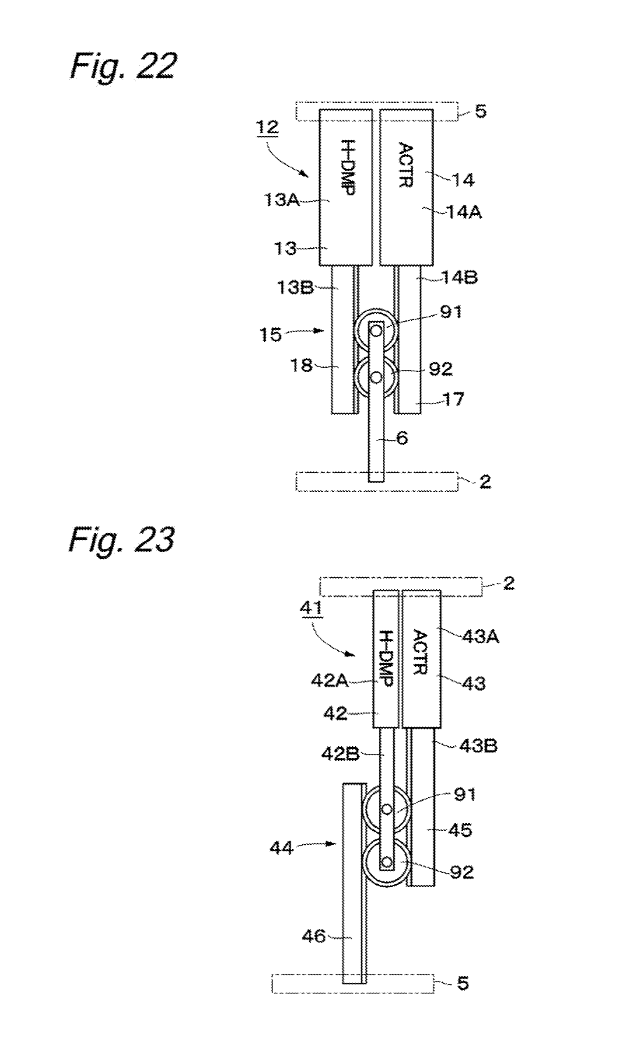

The above-described first and second embodiments have been described based on the example in which the gear apparatus 15 or 44 includes the single pinion 19 or 47. However, the present invention is not limited thereto. For example, the gear apparatus 15 or 44 may be configured to include a plurality of pinions 91 and 92 arranged in parallel, like a fifth modification illustrated in FIG. 22 and a sixth modification illustrated in FIG. 23. FIG. 22 corresponds to a modification of the first embodiment, and FIG. 23 corresponds to a modification of the second embodiment. In this case, the strength and the durability of the portions where the racks 17 and 18 or 45 and 46 are meshed with the pinions 91 and 92 can be enhanced.

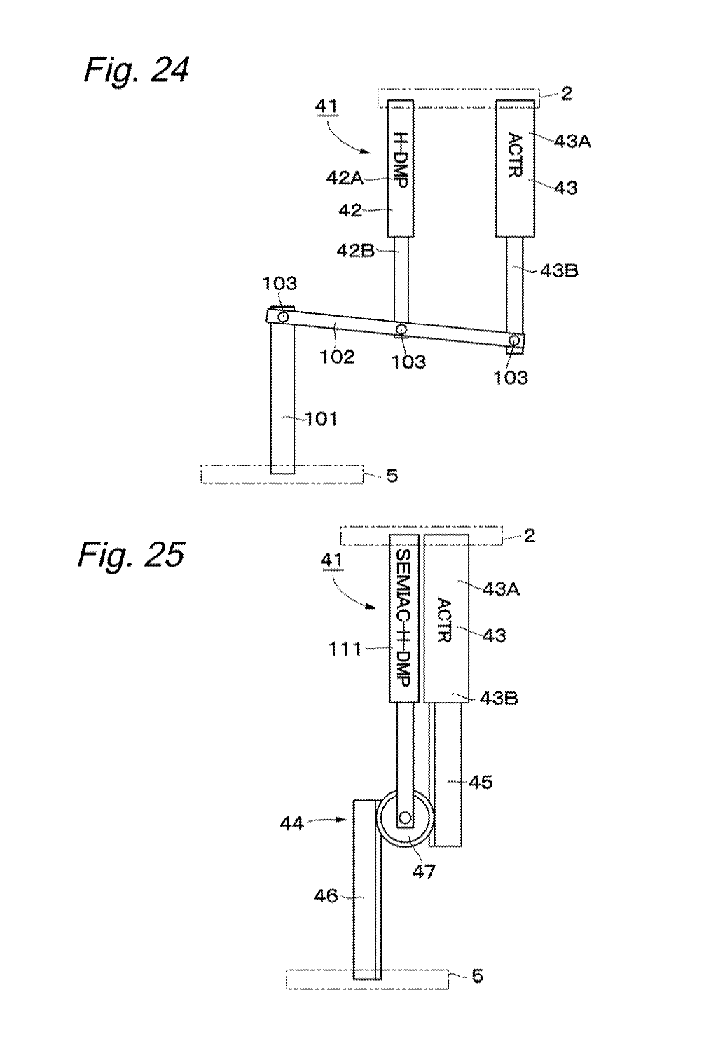

The above-described first and second embodiments have been described based on the example in which the switching unit is realized by the gear apparatus 15 or 44 constituted by the racks 17 and 18 or 45 and 46, and the pinion 19 or 47. However, the present invention is not limited thereto. For example, the switching unit may be configured in such a manner that the rod 42B of the attenuation damper 42, the movable element 43B of the electric damper 43, and a vehicle body coupling member 101 disposed on the vehicle body side are coupled to one another via a coupling rod 102, like a seventh modification illustrated in FIG. 24. In this case, the coupling rod 102 swingably couples the rod 42B, the movable element 43B, and the vehicle body coupling member 101 via rotational support members 103 such as bearings and pins. FIG. 24 corresponds to a modification of the second embodiment.

The above-described first and second embodiments have been described based on the example in which a damper capable of exerting a constant damping force is employed as the attenuation damper 13 or 42. However, the present invention is not limited thereto, and for example, may be configured in such a manner that a damper capable of exerting an adjustable damping force (a semi-active damper) is employed as an attenuation damper 111, like an eighth modification illustrated in FIG. 25.

In this case, both the forces (the thrust force and the damping force) generated by the electric damper 43 and the attenuation damper 111 can be adjusted (controlled) when the dampers are connected in parallel (the electric damper 43 and the attenuation damper 111 can generate the force of the damper apparatus 41 in cooperation). More specifically, the attenuation damper 111 is mainly in charge of a resistance force in the force generated by the damper apparatus 41, and the electric damper 43 is mainly in charge of an assist force in the force generated by the damper apparatus 41. This arrangement can reduce power consumption while reducing a vibration of the vehicle. Further, when the attenuation damper 111 is in charge of the resistance force, power consumption can be further reduced by causing the electric damper 43 to operate in a regeneration region.

The above-described first embodiment has been described based on the example in which the pinion 19 of the gear apparatus 15 is configured to be disposed so as to surround the central pin 6 of the vehicle body 2. However, the present invention is not limited thereto. For example, the pinion may be configured to be disposed at a position offset from the central pin (a pole of the traction apparatus). In other words, the gear apparatus (the switching unit) can be disposed at, for example, a portion between the vehicle body and the bogie that does not interfere with another member according to the configuration between the bogie and the vehicle body, the configuration of the traction apparatus, and the like. The same also applies to the second and third embodiments.

The above-described respective embodiments have been described based on the example in which the damper apparatus 12, 41, or 51 as the force generation mechanism is configured in such a manner that the attenuation damper 13, 42, or 52 and the electric damper 14, 43, or 65 are mounted on the vehicle such as the railway vehicle (between the vehicle body 2 and the bogie 5 thereof) while being horizontally placed. However, the present invention is not limited thereto. For example, the force generation mechanism may be configured in such a manner that the attenuation damper and the electric damper are mounted on a vehicle such as an automobile (between a vehicle body and an axle thereof) while being vertically placed.

The above-described respective embodiments have been described based on the example in which the damper apparatus 12, 41, or 51 as the force generation mechanism is mounted on the vehicle. However, the present invention is not limited thereto. For example, the damper apparatus may be applied to an electromagnetic suspension used for various kinds of machines, buildings, and the like that serve as vibration sources.

According to the above-described embodiments, it is possible to generate a desired force according to a condition.

More specifically, the force generation apparatus can switch the one force generation unit and the another force generation unit between the series connection and the parallel connection by the switching unit. Therefore, the force generation apparatus can generate the desired force using one or both of the one force generation unit and the another force generation unit by switching the series connection and the parallel connection with use of the switching unit according to the condition.

According to the embodiments, the switching unit can switch the attenuation damper and the electric damper between the series connection and the parallel connection. Therefore, the force generation apparatus can generate the desired force using one or both of the attenuation damper and the electric damper by switching the series connection and the parallel connection with use of the switching unit according to condition. In this case, for example, by setting the series connection with use of the switching unit and locking (fixing) one of the attenuation damper and the electric damper, the force generation apparatus can use the other damper alone. Further, for example, the force generation apparatus can acquire forces from both the attenuation damper and the electric damper by setting the parallel connection with use of the switching unit.

According to the embodiments, the switching unit is constituted by the racks and the pinion, whereby the force generation apparatus can stably transmit the force via the switching unit regardless of whether the switched state (the operation mode) is the series connection or the parallel connection. In this case, the switching unit can be constituted by the pinion and the pair of racks meshed with the pinion. One of the rod and the cylinder of the attenuation damper, and one of the stator and the movable element of the electric damper can be mounted on the one member. Any of the three members, the pinion and the pair of racks can be mounted on the other of the rod and the cylinder of the attenuation damper. Any of the remaining two members can be mounted on the other of the stator and the movable element of the electric damper. The remaining one member can be mounted on the other member.

According to the embodiments, the frictional force of the gear of the pinion is variable. Therefore, the switched state can be switched to, for example, the series connection by setting the frictional force to zero (allowing the pinion to freely rotate). On the other hand, the switched state can be switched to, for example, the parallel connection by maximizing the frictional force (prohibiting the pinion from rotating). In this case, the passive state and the active state can be switched by providing the lock apparatus (the brake apparatus) that limits (blocks or prohibits) a relative movement (extraction/compression) to at least one of the one force generation unit (for example, the electric damper) and the another force generation unit (for example, the attenuation damper).

According to some embodiments, the force generation mechanism is configured to be used as the left-right movement damper disposed between the vehicle body and the bogie, and therefore can stably generate the desired force between the vehicle body and the bogie according to the condition. As a result, the performance of the railway vehicle can be improved.

### REFERENCE SIGNS LIST

2 vehicle body (one member or the other member)
5 bogie (the other member or one member)
12, 41, 51 damper apparatus (force generation mechanism, left-right movement damper apparatus)
13, 42, 52, 111 attenuation damper (force generation unit)
13A, 42A, 53 cylinder
13B, 42B rod
14, 43, 65, 71 electric damper (force generation unit)
14A, 43A, 65A stator
14B, 43B, 65B movable element
15, 44 gear apparatus (switching unit)
17, 18, 45, 46 rack
19, 47, 81, 91, 92 pinion
20 pinion brake apparatus
59 first rod
80 second rod
66 flow amount adjustment apparatus (switching unit)
67 attenuation damper lock apparatus (switching unit)
102 coupling rod (switching unit)

1. A force generation mechanism configured to be mounted between two members that are one member and the other member relatively movable to each other, the force generation mechanism comprising:
a plurality of direct-drive force generation units; and
a switching unit disposed between one and another of the force generation units and capable of mechanically switching the one and the another force generation units between a series connection and a parallel connection.

2. The force generation mechanism according to claim 1, wherein the switching unit switches a ratio of forces generated by the one and the another force generation units by mechanically connecting the one and the another force generation units in series or in parallel.

3. The force generation mechanism according to claim 1, wherein the one force generation unit is an attenuation damper including a rod protruding from a cylinder and configured to generate a damping force by converting motion energy of a forward or backward movement of the rod into heat energy, and
wherein the another force generation unit is an electric damper including a stator and a movable element linearly movable relative to the stator.

4. The force generation mechanism according to claim 1, wherein the switching unit includes a rack and a pinion.

5. The force generation mechanism according to claim 4, wherein a frictional force of a gear of the pinion is variable.

6. The force generation mechanism according to claim 1, wherein the one member is a vehicle body, and the other member is a bogie, and
wherein the force generation mechanism is a left-right movement damper apparatus.

7. The force generation mechanism according to claim 6, wherein a pneumatic spring configured to support the vehicle body swingably relative to the bogie in a vertical direction and a left-right direction is provided between the vehicle body and the bogie.

8. The force generation mechanism according to claim 6, wherein the rack is mounted on each of the rod of the attenuation damper and the movable element of the electric damper, and the pinion is mounted on the vehicle body.

9. The force generation mechanism according to claim 8, wherein the pinion is disposed concentrically with a rotational center of the bogie.

10. The force generation mechanism according to claim 2, wherein the one force generation unit is an attenuation damper including a rod protruding from a cylinder and configured to generate a damping force by converting motion energy of a forward or backward movement of the rod into heat energy, and
wherein the another force generation unit is an electric damper including a stator and a movable element linearly movable relative to the stator.

11. The force generation mechanism according to claim 2, wherein the switching unit includes a rack and a pinion.

12. The force generation mechanism according to claim 3, wherein the switching unit includes a rack and a pinion.

13. The force generation mechanism according to claim 2, wherein the one member is a vehicle body, and the other member is a bogie, and
wherein the force generation mechanism is a left-right movement damper apparatus.

14. The force generation mechanism according to claim 3, wherein the one member is a vehicle body, and the other member is a bogie, and
wherein the force generation mechanism is a left-right movement damper apparatus.

15. The force generation mechanism according to claim 4, wherein the one member is a vehicle body, and the other member is a bogie, and
wherein the force generation mechanism is a left-right movement damper apparatus.

16. The force generation mechanism according to claim 5, wherein the one member is a vehicle body, and the other member is a bogie, and
wherein the force generation mechanism is a left-right movement damper apparatus.
